(19) United States
(12) Patent Application Publication
(10) Pub. No.: US 2021/0289336 A1
(43) Pub. Date: Sep. 16, 2021

(54) SYSTEMS AND METHODS FOR SMART DEVICES

(71) Applicant: Facebook Technologies, LLC, Menlo Park, CA (US)

(72) Inventors: Zhong Zhang, Santa Clara, CA (US); Jiansong Wang, Lincroft, NJ (US); Sixue Chen, Dallas, TX (US); Insoo Hwang, Sammamish, WA (US); Swaminathan Balakrishnan, Los Gatos, CA (US); Ran Rubin, New York, NY (US); Johnny Kallacheril John, San Diego, CA (US); Philip Richard Pottier, San Diego, CA (US); James Leon Garrison, San Diego, CA (US); Brian Richard Costabile, San Diego, CA (US); Chengyuan Yan, San Bruno, CA (US); Yue Kwen Justin Yip, Mountain View, CA (US)

(21) Appl. No.: 17/335,797

(22) Filed: Jun. 1, 2021

Related U.S. Application Data
(60) Provisional application No. 63/104,537, filed on Oct. 23, 2020.
(60) Provisional application No. 63/143,504, filed on Jan. 29, 2021.
(60) Provisional application No. 63/148,812, filed on Feb. 12, 2021.
(60) Provisional application No. 63/164,180, filed on Mar. 22, 2021.
(60) Provisional application No. 63/179,960, filed on Apr. 26, 2021.

(51) Int. Cl. H04W 4/90; H04W 4/029; H04W 56/00; H04W 8/18; G06T 7/70

(52) U.S. Cl. CPC H04W 4/90; H04W 4/029; H04W 56/0055; G06T 2207/20081; G06T 7/70; G06T 2207/30201; H04W 8/18

(57) ABSTRACT

The disclosed systems may include systems and methods for clock synchronization under random transmission delay conditions. Additionally, systems and methods for horizon leveling for wrist captured images may be disclosed. In addition, the disclosed may include methods, systems, and devices for batch message transfer. The disclosed methods may also include a mobile computing device receiving an indication to initiate an emergency voice call by a user of the mobile computing device and initiating an Internet Protocol Multimedia Subsystem (IMS) emergency call. In addition, systems, methods, and devices for automatic content display may be disclosed. Various other related methods and systems are also disclosed.

This application claims the benefits of U.S. Provisional Application No. 63/104,537, filed Oct. 23, 2020, U.S. Provisional Application No. 63/143,504, filed Jan. 29, 2021, U.S. Provisional Application No. 63/148,812, filed Feb. 12, 2021, U.S. Provisional Application No. 63/164,180, filed Mar. 22, 2021, and U.S. Provisional Application No. 63/179,960, filed Apr. 26, 2021, the disclosures of each of which are incorporated, in their entirety, by this reference.

### BRIEF DESCRIPTION OF DRAWINGS AND APPENDICES

The accompanying drawings illustrate a number of exemplary embodiments and are a part of the specification. Together with the following description, these drawings demonstrate and explain various principles of the present disclosure.

FIG. 1 is an illustration of an exemplary time synchronization protocol.

FIGS. 2A and 2B are illustrations of an exemplary human-machine interface configured to be worn around a user's lower arm or wrist.

FIGS. 3A and 3B are illustrations of an exemplary schematic diagram with internal components of a wearable system.

FIGS. 4A and 4B are diagrams of an example wearable electronic wrist device.

FIG. 5 is a flow chart of a method for horizon leveling of captured images.

FIGS. 6A-C depict an example captured image and horizon leveling examples thereof.

FIGS. 7A-C depict another example captured image and horizon leveling examples thereof.

FIG. 8 is a perspective view of an example wristband system, according to at least one embodiment of the present disclosure.

FIG. 9 is a perspective view of a user wearing an example wristband system, according to at least one embodiment of the present disclosure.

FIG. 10 illustrates a smartphone transferring messages to a wearable device, according to at least one embodiment of the present disclosure.

FIG. 11 is a chart illustrating normalized power consumption of a wireless communications unit as a function of aggregate message size, according to at least one embodiment of the present disclosure.

FIG. 12 is flowchart of a method of reducing power consumption in a wireless communications unit by batch messaging, according to at least one embodiment of the present disclosure.

FIG. 13 is an illustration of a user interacting with a mobile computing device capable of placing E911 service calls.

FIG. 14 is a flow diagram of an exemplary computer-implemented method for implementing an E911 emergency service on a mobile computing device.

FIG. 15 is a block diagram of an example system that includes modules for use in implementing E911 call support for a mobile computing device.

FIG. 16 illustrates an exemplary network environment in which aspects of the present disclosure may be implemented.

FIG. 17 is a flow diagram of an exemplary computer-implemented method for providing emergency voice call services and support on mobile computing devices.

FIG. 18 is a plan view of an example wristband system, according to at least one embodiment of the present disclosure.

FIG. 19 illustrates a user wearing an example wristband system, according to at least one embodiment of the present disclosure.

FIG. 20 illustrates a user viewing content on an example wristband system, according to at least one embodiment of the present disclosure.

FIG. 21 is an example block diagram of a wristband system, according to at least one embodiment of the present disclosure.

FIG. 22 is a flow diagram illustrating an example method of automatically displaying content on an example wristband system, according to at least one embodiment of the present disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within this disclosure.

### DETAILED DESCRIPTION

### Example Systems and Methods for Clock Synchronization Under Random Transmission Delay Conditions

A host system that relies on real-time data from multiple devices may rely on accurate timestamps associated with the data from the devices in order to accurately integrate the data from diverse sources. However, separate clocks, even if initially synchronized, may tend to drift from each other over time. Systems and methods are described herein that obtain an accurate representation of multiple clocks for separate devices (i.e., their rates and relative offsets). By obtaining an accurate representation of the devices' clocks, these systems and methods facilitate synchronizing inputs from the devices (e.g., from two or more EMG devices, allowing a host system to obtain an accurate neuromuscular and/or musculoskeletal representation of a user wearing the EMG devices). Bidirectional communication of simple time synchronization packets may be used to estimate devices' clock rates and offsets accurately. The clocks of multiple devices may thereby be kept in sync with a host system's clock, ensuring that the host system has an accurate view of the timing of inputs from the devices.

In some examples, the systems and methods described herein may use a recursive least squares algorithm to estimate transmission delays of timestamped data (e.g., sent from devices with separate clocks to a host system). The recursive least squares algorithm may use adaptive bounds based on observed transmission delays from a device (e.g., the lowest transmission delays may be taken as related to the minimum transmission delay from the device (e.g., within a constant offset of a substantially constant minimum transmission delay)).

In one example, a host system clock may estimate the offset and the period of a device clock using a bidirectional time synchronization protocol. For example, the host system may send a message (including, e.g., the time of the host system clock) to the device. The device may send a return message to the host system that includes the time recorded by the device clock when the host system message was received by the device, the time recorded by the device clock when the device return message was sent to the host system, and, in some examples, the time recorded by the host system clock when the host system message was sent.

In some examples, the systems and methods described herein may repeat the bidirectional communication process multiple times and may, thereby, estimate the period of the device clock using linear regression and may bound the offset of the device clock with the constraint that all transmission delays must be positive. The systems described herein may determine the upper and lower bounds of the offset of the device clock by the minimum possible transmission delays in both directions.

In some embodiments, systems and methods described herein may use a recursive least squares algorithm with adaptive bounds. For example, the 1st percentile of observed transmission delays may remain within a constant offset of the constant minimum delay. Therefore, by tracking the 1st percentile and adjusting the model offset based on recent observations, the systems and methods described herein may more accurately estimate transmission delays.

In order to synchronize inputs arriving from independent devices (e.g., 2 EMG devices), the systems described herein may obtain an accurate representation of each devices' clock in terms of the host PC clock. While estimating the sample time of incoming data streams using only unidirectional communication (i.e., device to host PC) is possible, it could be less accurate than using bidirectional time synchronization protocols (as is done in NTP and almost all other time synchronization algorithms). In particular, the offset between device clock and host PC clock cannot be determined due to possible, unobservable, deterministic transmission delays.

In view of the above, systems described herein may use bidirectional communication of simple time synchronization packets to enable estimation of the device clock's rate and offset accurately. By incorporating such communication protocols into independent devices (e.g., 2 EMG devices), these systems will be able to keep all connected devices in sync with the host PC's clock and have high confidence that the pipeline is not affected by unknown timing issues.

The approaches to sync the device clock to the host PC clock described herein may be robust to various sources of noise (including, e.g., clock drift and non-stationary delay distribution). These approaches may be applied to a setup to estimate a device's clock rate and an upper bound on its offset (even without bidirectional communication). In addition, the systems described herein may estimate how well these perform in synchronizing two devices under realistic conditions. The benefit of implementing bidirectional communication for time sync protocol, even without knowing the minimal transmission delay time and how it varies, may be estimated by running dual-band experiments under various conditions (many bands, environments, etc.).

The solution detailed herein may also include a mechanism to adjust various parameters (such as time decay constants) based on streaming data statistics.

The term “clock” may refer to any device that measures time by the number of ticks that passes in a given time interval. Note that having a clock does not necessarily provide the capability of telling what time it is. Nor is it necessarily known how one clock relates to other clocks. Only if a clock is stable, and its rate and offset are known relative to, for example, a standard atomic clock, can the time at each tick be calculated for the clock.

However, there is no such thing as a perfectly stable clock. All clocks have fluctuations in the rate of ticking (though for some these fluctuations are very small) that cause them to drift away from each other. Thus, if there are two clocks to synchronize (i.e., to model the relations between the ticks of one clock to the ticks of the other), a method may include continuously monitoring this drift and updating the model used to convert time from one clock to time in another.

Consider two clocks: A master clock (e.g., the host PC clock) and a slave clock (e.g., the device sample clock). For convenience, assume that the master clock ticks faster than the slave clock. Then, mark the clock ticks of the master clock as and the ticks of the slave clock with u. Consider a span of time t for which u and t and are stable with respect to each other. This implies a linear relationship between u and t: t (u)=t₀+τu.

The goal of a time synchronization protocol (in the present case) includes enabling the host PC (having access to the master clock) to estimate the offset, t₀, and the period, τ, of the slave clock.

However, u and t cannot be observed simultaneously, but only through a communication channel that carries some unknown (and, e.g., varying) transmission delay. The bidirectional time sync protocol described herein may therefore exchange clock time information between master and slave in a way to allow averaging out the random delays and having a good estimate of t₀ and τ.

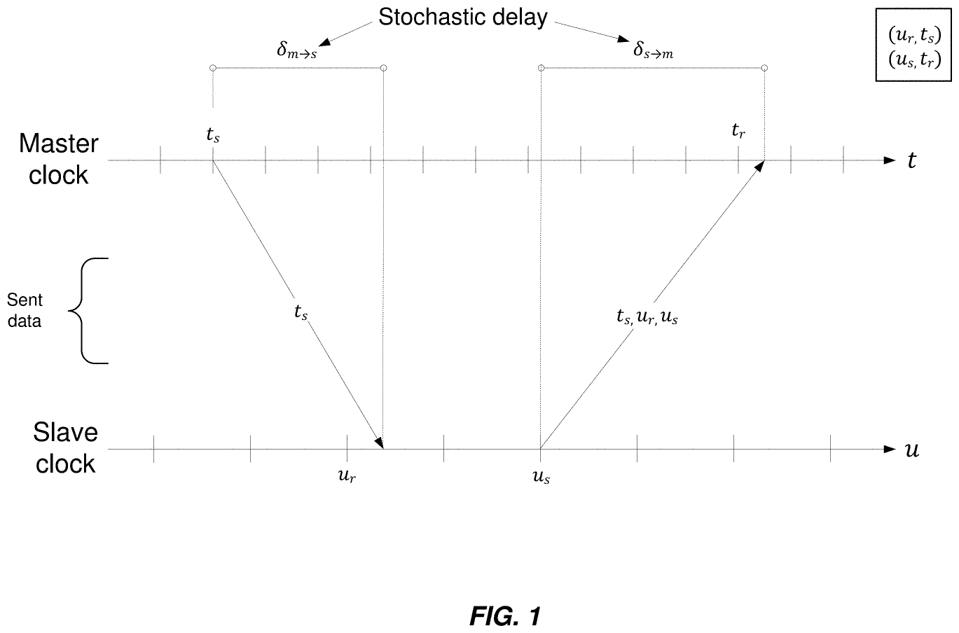

An example process is described with reference to FIG. 1. The master clock (or “second clock”) sends (in a first transmission) its own time to the slave clock (or “first clock”) at some time tₛ, which is received by the slave clock with some unknown delay, at some time ur. After a short while, the slave clock then sends (in a second transmission) its own time uₛ>uᵣ, along with tₛ and uᵣ, back to the master clock. After an additional unknown delay, tₛ, uᵣ, and uₛ (recorded as first, second, and third timestamps, respectively) are received by the master clock at time tᵣ (recorded as a fourth timestamp).

The master clock now has two noisy measurements of t as a function of u: (uᵣ, tₛ) and (uₛ, tᵣ). By repeating this process many times one can estimate τ using linear regression and bind to using causality constraints (i.e., all delays must be positive). The upper and lower bounds of to are determined by the minimal possible transmission delays in both directions. If the ratio between the minimal possible delays is known, a precise estimate of to can be derived as well.

The upper and lower bounds of to may be derived as follows. Assume a linear relationship between t and u:

t(u)=t₀+τu (1)

During the time sync protocol, the master clock sends its own time, tₛ, to the slave clock. This information is received at the slave clock's device at time

uᵣ=└(tₛ+δ_{m→s}−t₀)/τ┘ (2)

where δ_{m→s} is a random transmission delay that is distributed according to some probability distribution

δ_{m→s}∝P_{m→s}(δ;δ_{m→s}^{min}, . . . ) (3)

where δ_{m→s}^{min}>0 and P_{m→s} is such that P_{m→s}(δ; δ_{m→s}^{min}, . . . )=0 for all δ<δ_{m→s}^{min}. Assume that this distribution is stationary and does not change in time. At some time, uₛ>uᵣ, the slave clock sends its own time back to the master clock, along with tₛ and uᵣ. This information is received back at the master clock at time

tᵣ=└t₀+τuₛ+δ_{s→m}┘ (4)

where δ_{s→m} is a random transmission delay that is distributed according to some, possibly different, probability distribution

δ_{s→m}∝P_{s→m}(δ;δ_{s→m}^{min}, . . . ) (5)

where δ_{s→m}^{min}>0 and, similarly to P_{m→s}, P_{s→m} is such that P_{s→m}(δ; δ_{s→m}^{min}, . . . )=0 for all δ<δ_{s→m}^{min}. Only the times tₛ, uᵣ, uₛ, and tᵣ are observable but not the offset, period, or random delays.

Given this model for transmission delays, consider a set of measurements {(tₛ, uᵣ)ᵢ}ᵢ₌₁^{N} and {(tᵣ, uₛ)ᵢ}ᵢ₌₁^{M}. Estimate τ by linear regression and denote the estimated period as τ\hat{ }. If the distributions of delays in both directions are identical, and M=N, then the offset parameter given by the linear regression converges to the true offset, t₀, as the number of measurements approaches infinity. However, if the distributions are different, the linear regression offset will be biased.

In one example, the systems described herein may use causality considerations to derive hard bounds on tₒ. For any measurement of (tₛ, uᵣ)ᵢ, re-write uᵣ as:

uᵣ=└(tₛ+δ_{m→s}−t₀)/τ┘≡(tₛ+δ_{m→s}−tₒ)/τ−∈ (6)

where 0≤∈<1 denotes the remainder of the floor operation. Now use the fact that δ_{m→s}≥δ_{m→s}^{min} to assert that for every measurement:

$$\begin{matrix}{t}_{o} + τ {u}_{r} - {t}_{s} + τ ϵ \geq {δ}_{m \to s}^{min} \\ ⇓ & ( 7 ) \\ {t}_{o} + τ {u}_{r} - {t}_{s} \geq {δ}_{m \to s}^{min} - τ ϵ & ( 8 )\end{matrix}$$

Since the δ_{m→s}^{min} and ∈ are not known, the right-hand side of the above equation can be bounded by δ_{m→s}^{min}−τ∈≥−τ. Thus:

tₒ≥tₛ−τuᵣ−τ. (9)

In a similar manner, assert that for every measurement of (tᵣ, uₛ)ᵢ:

$$\begin{matrix}{t}_{r} = ⌊ {t}_{o} + τ {u}_{s} + {δ}_{s \to m} ⌋ ≡ {t}_{o} + τ {u}_{s} + {δ}_{s \to m} - ϵ \\ ⇓ & ( 10 ) \\ {t}_{r} - {t}_{o} - τ {u}_{s} \geq {δ}_{s \to m} - ϵ \geq - 1 \\ ⇓ & ( 11 ) \\ {t}_{o} \leq {t}_{r} - τ {u}_{s} + 1 & ( 12 )\end{matrix}$$

Since equations (9) and (12) must hold for all measurements, it follows that:

tₒ≥maxᵢ(tₛ−τuᵣ)−τ (13)

and

tₒ≤minᵢ(tᵣ−τuₛ)+1 (14)

The systems described herein may require that these bounds will hold for the estimates of the offset and period: i.e., for a given estimate of the period τ\hat{ }:

t₀^{UB}≡minᵢ(tᵣ−τ\hat{ }uₛ)+1 (15)

t₀^{LB}≡minᵢ(tₛ−τ\hat{ }uᵣ)−τ\hat{ } (16)

t₀^{LB}≤tₒ≤t₀^{UB} (17)

Further, given that the systems described herein collect enough samples (and the delay distribution is stationary) it is safe to assume that the estimate for the minimal delay is very close to the actual unknown minimal possible delay. That is, the offset estimate, tₒ, obeys the following 2 equations:

tₒ−t₀^{LB}≅δ_{m→s}^{min} (18)

t₀^{UB}−tₒ≅δ_{s→m}^{min} (19)

If the minimal transmission delay is assumed to be symmetric (i.e. δ_{m→s}^{min}=δ_{s→m}^{min}≡δ^{min}), then solve for tₒ:

tₒ=½(t₀^{UB}+t₀^{LB}) (20)

δ^{min}=½(t₀^{UB}−t₀^{LB}) (21)

Systems described herein may evaluate the offset and the period in an online (e.g., real-time) scenario. To this end, these systems may apply a recursive least squares algorithm to the data (e.g., tₛ, uₛ, tᵣ, uᵣ), as well as continuously update the upper- and lower-bounds estimates to evaluate the offset and period based only on past observations.

Systems described herein may operate under certain assumptions, including, e.g., that the master clock and slave clock are substantially stable relative to each other (i.e., little or no clock drift) and that the distribution of transmission delays is substantially stationary.

To model click draft, the linear model t(u)=t₀+τu is replaced with a stochastic process:

t(u)=t₀+τu (22)

τ(u)∝P(τ(u)|τ(u−1),τ(u−2), . . . ) (23)

A simple linear model may not fit the data well. Accordingly, systems described herein may limit the amount of data used to fit the parameters on to the most recent data within a given window.

In one example, one or more separate devices (with separate clocks) may transmit timestamped data to a host system over a period of time. In some examples, systems described herein may provide high-accuracy clock estimates (e.g., mapping clock and/or timestamp information relating to transmitting devices to clock and/or timestamp information relating to a host system) and/or may provide a guarantee that the time deltas between consecutive timestamps are accuracy within a given tolerance level around a given nominal rate.

In some examples, transmission delays between a device and a host system may be non-stationary (e.g., may exhibit a bimodal distribution). Systems described herein may therefore employ a recursive least squares algorithm with adaptive bounds constraints to improve accuracy of clock metrics and/or timestamp estimates.

In one approach, systems described herein may estimate transmission delays by fitting a single linear model (t(u)=t₀+τu), where x is determined by linear regression and to by the causality constraints that all delays must be non-negative. In some examples, minimal delay may vary slowly over time due to clock drifts. When many delays are sampled over time, the shorter end of the distribution (e.g., the 1^{st} percentile of delays according to a window of most recent delays over time) may vary slowly and smoothly and may be largely unaffected by large changes in mean delays and delay variability.

Accordingly, systems described herein may track a statistical metric of delays over time (e.g., 1st percentile of delays according to a window of most recent delays over time, or, more generally, a selected low percentile (0.5, 1, 1.5, 2, 5, etc.)) and adjust the model offset based on recent observations such that the 1st percentile delays will always be 0.

In order to account for clock drift, the systems described herein may apply exponentially decaying weights to a recursive least squares algorithm.

In some examples, using the methods described above, systems described herein may achieve very high accuracy of clock estimations. The variance in the error may fall within a single time step (e.g., +/−0.5 milliseconds).

In some examples, the systems described herein may implement a restriction so that time steps will always be within pre-defined tolerance levels. This may address otherwise unconstrained variability in time step size and/or may prevent time steps from being reckoned as negative.

In addition, in some examples the systems described herein may apply a warm-up period (e.g., lasting approximately 4 seconds) in which the timestamps are given using the nominal rate and raw timing data is collected to estimate the initial offset parameter. Furthermore, in some examples, the initial precision matrix of the recursive least squares algorithm may be configured to reflect the actual observation rate of the device clock (e.g., every 8 samples in a batch instead of every 1 sample):

$${P}_{0} = {[ {\sum }_{u = - ∞}^{0} {α}^{- u} ( \begin{matrix}{n}_{b} u \\ 1\end{matrix} ) ( {n}_{b} u 1 ) ]}^{- 1}$$

where, using the earlier-related example, n_{b}=8 is the number of samples in a batch.

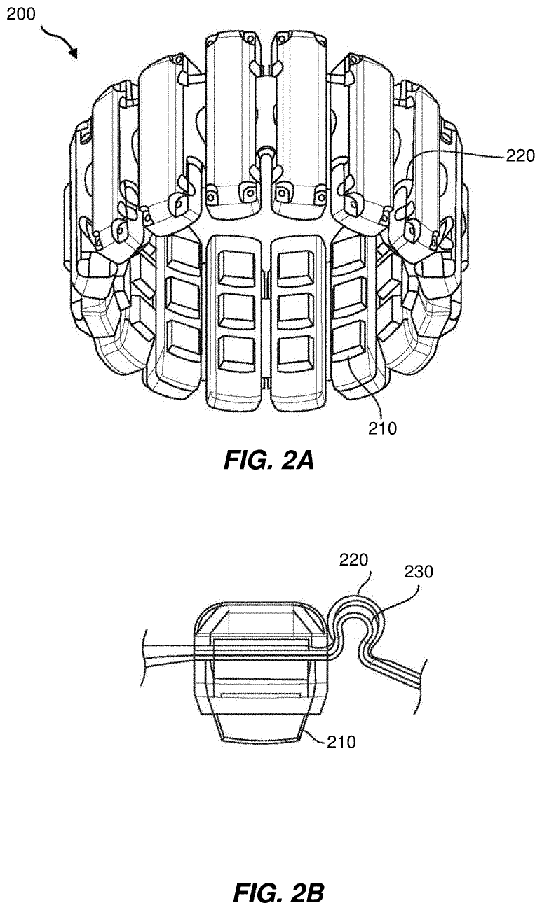

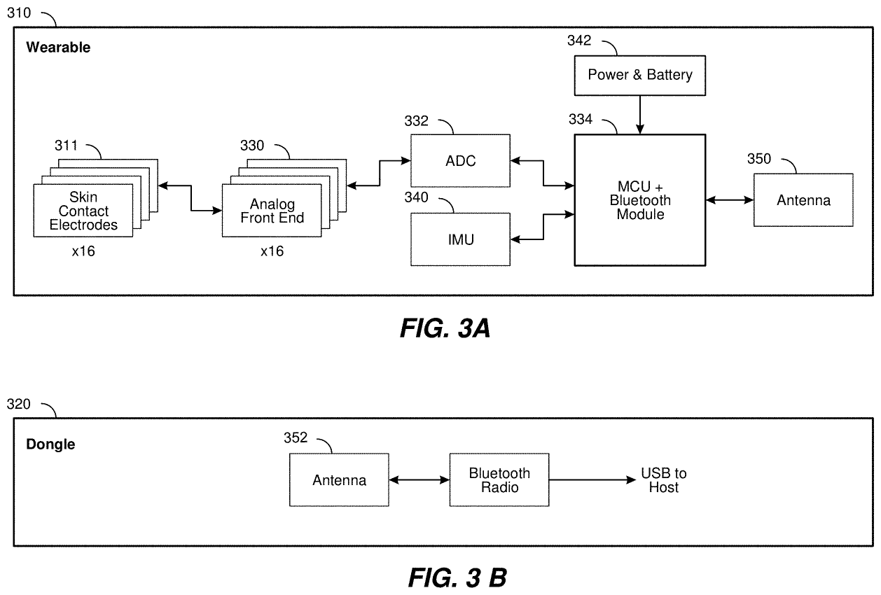

FIGS. 2A-3B illustrate example devices that may benefit from the clock synchronization approaches detailed herein. Specifically, FIG. 2A illustrates an exemplary human-machine interface (also referred to herein as an EMG control interface) configured to be worn around a user's lower arm or wrist as a wearable system 200. In this example, wearable system 200 may include sixteen neuromuscular sensors 210 (e.g., EMG sensors) arranged circumferentially around an elastic band 220 with an interior surface 230 configured to contact a user's skin. However, any suitable number of neuromuscular sensors may be used. The number and arrangement of neuromuscular sensors may depend on the particular application for which the wearable device is used. For example, a wearable armband or wristband can be used to generate control information for controlling an augmented reality system, a robot, controlling a vehicle, scrolling through text, controlling a virtual avatar, or any other suitable control task. As shown, the sensors may be coupled together using flexible electronics incorporated into the wireless device. FIG. 2B illustrates a cross-sectional view through one of the sensors of the wearable device shown in FIG. 2A. In some embodiments, the output of one or more of the sensing components can be optionally processed using hardware signal processing circuitry (e.g., to perform amplification, filtering, and/or rectification). In other embodiments, at least some signal processing of the output of the sensing components can be performed in software. Thus, signal processing of signals sampled by the sensors can be performed in hardware, software, or by any suitable combination of hardware and software, as aspects of the technology described herein are not limited in this respect. A non-limiting example of a signal processing chain used to process recorded data from sensors 210 is discussed in more detail below with reference to FIGS. 3A and 3B.

FIGS. 3A and 3B illustrate an exemplary schematic diagram with internal components of a wearable system with EMG sensors. As shown, the wearable system may include a wearable portion 310 (FIG. 3A) and a dongle portion 320 (FIG. 3B) in communication with the wearable portion 310 (e.g., via BLUETOOTH or another suitable wireless communication technology). As shown in FIG. 3A, the wearable portion 310 may include skin contact electrodes 311, examples of which are described in connection with FIGS. 2A and 2B. The output of the skin contact electrodes 311 may be provided to analog front end 330, which may be configured to perform analog processing (e.g., amplification, noise reduction, filtering, etc.) on the recorded signals. The processed analog signals may then be provided to analog-to-digital converter 332, which may convert the analog signals to digital signals that can be processed by one or more computer processors. An example of a computer processor that may be used in accordance with some embodiments is microcontroller (MCU) 334, illustrated in FIG. 3A. As shown, MCU 334 may also include inputs from other sensors (e.g., IMU sensor 340), and power and battery module 342. The output of the processing performed by MCU 334 may be provided to antenna 350 for transmission to dongle portion 320 shown in FIG. 3B.

Dongle portion 320 may include antenna 352, which may be configured to communicate with antenna 350 included as part of wearable portion 310. Communication between antennas 350 and 352 may occur using any suitable wireless technology and protocol, non-limiting examples of which include radiofrequency signaling and BLUETOOTH. As shown, the signals received by antenna 352 of dongle portion 320 may be provided to a host computer for further processing, display, and/or for effecting control of a particular physical or virtual object or objects.

Although the examples provided with reference to FIGS. 2A-2B and FIGS. 3A-3B are discussed in the context of interfaces with EMG sensors, the techniques described herein for reducing electromagnetic interference can also be implemented in wearable interfaces with other types of sensors including, but not limited to, mechanomyography (MMG) sensors, sonomyography (SMG) sensors, and electrical impedance tomography (EIT) sensors. The techniques described herein for reducing electromagnetic interference can also be implemented in wearable interfaces that communicate with computer hosts through wires and cables (e.g., USB cables, optical fiber cables, etc.).

### EXAMPLE EMBODIMENTS

Example 1: A system may include a first device with a first clock, a host system with a second clock, where the host system sends a first transmission to the first device at a first time measured by the first clock and identified by a first timestamp, receives a second transmission from the first device at a fourth time measured by the first clock and identified by a fourth timestamp, where the second transmission may include a second timestamp, measured by the second clock, indicating a second time at which the first transmission was received by the first device from the synchronization system, and a third timestamp, measured by the second clock, indicating a third time at which the second transmission as sent by the first device to the host system, and determines, based at least in part on the first, second, third, and fourth timestamps, an estimated offset of the second clock relative to the first clock and an estimated period of the second clock relative to the first clock.

### Example Systems and Methods for Horizon Leveling for Wrist Captured Image

Wearable electronic devices may provide various functionalities, such as the ability to capture images or take photographs using a camera or other image sensor. Although wearable devices may provide certain usability benefits, for instance by allowing hands-free usage or not requiring devices to be put away for carrying purposes, wearable devices may present certain usability drawbacks. Depending on where the device is worn, users may have difficulty in optimally performing certain functions, such as taking photographs. For example, when using a wrist-worn device such as a smartwatch, users may have difficulty positioning their arms to take level self-portrait or “selfie” photographs. In addition, even if a display of the smartwatch presents a viewfinder or image preview, it may be difficult for users to correctly position their arms to view the display and align their arms for taking photographs.

The present disclosure is generally directed to horizon leveling for wrist captured images. As will be explained in greater detail below, embodiments of the present disclosure may use sensors and/or data available on wearable devices to realign photographs, thereby countering a tilt that may be produced when taking photographs using wearable devices. By determining a reference orientation associated with captured image data and rotating the captured image data based on the reference orientation, the embodiments described herein may correct unwanted tilting in the image data.

Features from any of the embodiments described herein may be used in combination with one another in accordance with the general principles described herein. These and other embodiments, features, and advantages will be more fully understood upon reading the following detailed description in conjunction with the accompanying drawings and claims.

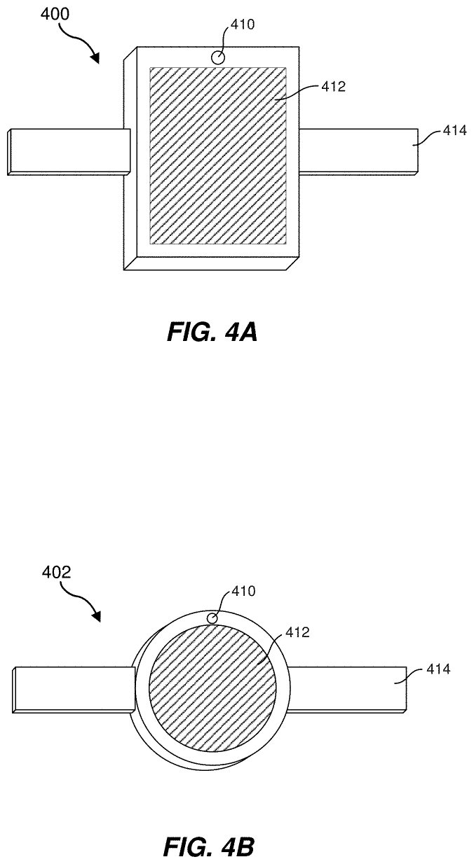

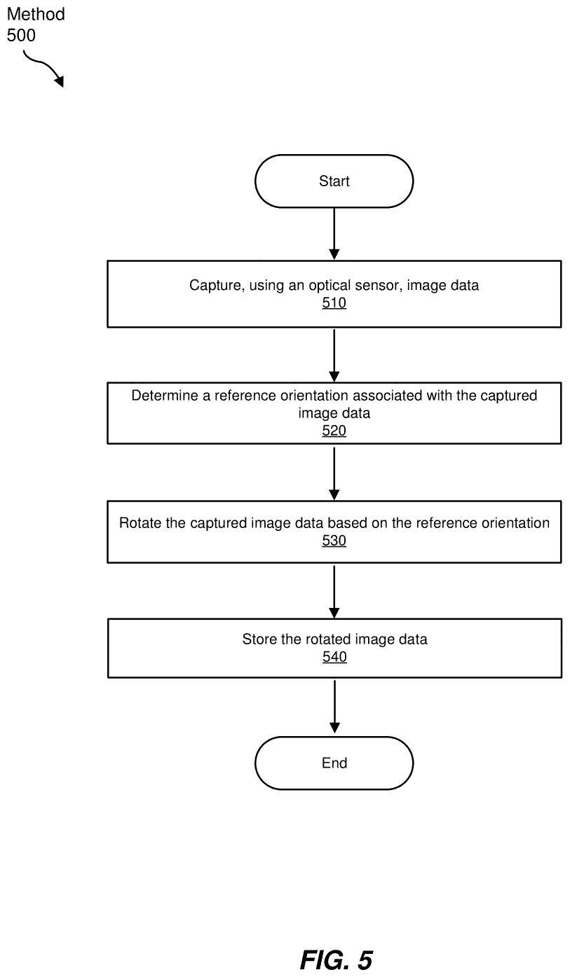

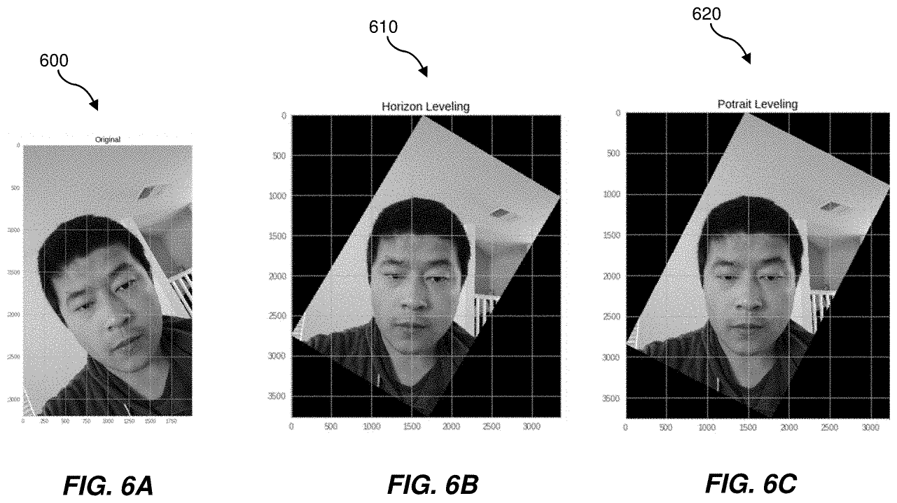

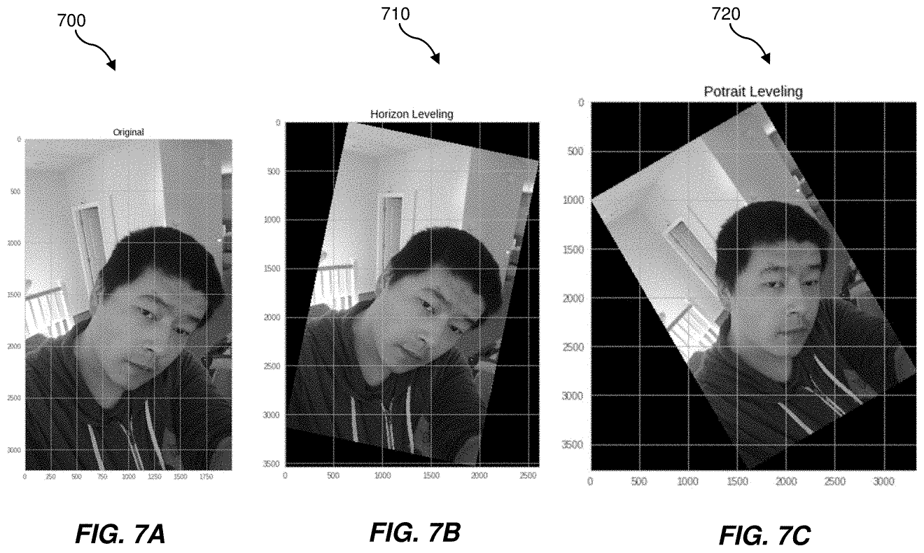

The following will provide, with reference to FIGS. 4A-7C, detailed descriptions of horizon leveling in captured images. Descriptions of example wearable devices are provided with reference to FIGS. 4A-B. Descriptions of a process of horizon leveling are provided with reference to FIG. 5. Descriptions of horizon leveled image examples are provided with reference to FIGS. 6A-7C.

FIGS. 4A-B are illustrations of example wearable device 400 and wearable device 402. Wearable devices 400 and/or 402 may correspond to, be incorporated with, be a portion of, or otherwise operate in conjunction with any of the devices and/or systems described herein. As seen in FIGS. 4A-B, wearable devices 400 and 402 may include an optical sensor 410 (e.g., a camera), a display 412 (e.g., a touchscreen or other type of display), and a band 414. Wearable device 400 may have a rectangular watch form and wearable device 402 (which may correspond to wearable device 400) may have a circular watch form, although in different examples wearable devices 400 and/or 402 may have different shapes. In other examples, wearable devices 400 and/or 402 may have different wearable form factors. Moreover, the positions or locations of components, such as optical sensor 410, may vary in other examples.

Wearable devices 400 and/or 402 may be computing devices such as smartwatches or other mobile devices. Although not shown in FIGS. 4A-B, wearable devices 400 and/or 402 may include additional components, such as an inertial measurement unit (IMU), one or more processors, and/or physical memory.

FIG. 5 is a flow diagram of an exemplary computer-implemented method 500 for horizon leveling of captured images. The steps shown in FIG. 5 may be performed by any suitable computer-executable code and/or computing system, including the devices illustrated in FIGS. 4A and/or 4B. In one example, each of the steps shown in FIG. 5 may represent an algorithm whose structure includes and/or is represented by multiple sub-steps, examples of which will be provided in greater detail below.

As illustrated in FIG. 5, at step 510 one or more of the systems described herein may capture, using an optical sensor, image data. For example, wearable device 400 may capture, using optical sensor 410, image data.

In some embodiments, the term “image data” may refer to a single frame or multiple frames. Examples of image data include, without limitation, photographs, videos, stereoscopic photographs, stereoscopic videos, etc.

The systems described herein may perform step 510 in a variety of ways. In one example, a user may push a button or otherwise provide an input to wearable device 400 to capture the image data. In other examples, the user may set a timer on wearable device 400 to capture the image data.

FIGS. 6A and 7A illustrate example captured images 600 and 700, respectively. As seen in FIG. 6A, captured image 600 may be a selfie of a user captured using a smartwatch, such as wearable device 400. Although the user's face may have a straight pose, captured image 600 may present the user's face at a tilt due to a position of the user's arm wearing wearable device 400 when captured image 600 was captured. Background objects, such as walls, may also similarly be presented at a tilt. As seen in FIG. 7, captured image 700 may be another selfie of the user captured using a smartwatch, such as wearable device 400. The user's face may have a tilted pose in captured image 700 (as seen in reference to background objects). However, the background objects, such as walls, may be presented at a tilt due to a position of the user's arm wearing wearable device 400 when captured image 700 was taken.

Returning to FIG. 5, at step 520 one or more of the systems described herein may determine a reference orientation associated with the captured image data. For example, wearable device 400 may determine a reference orientation associated with, for example, captured image 600 and/or 700.

In some embodiments, the term “reference orientation” may refer to a desired orientation for aligning or orienting image data. In some examples, a reference orientation may correspond to a global orientation in which a horizon (e.g., surface of the Earth) is level. When an image aligns with the global orientation, a positive y-axis (e.g., an upward direction in the image) may align with a direction perpendicular or normal to the horizon, a negative y-axis (e.g., a downward direction in the image) may align with a direction of gravity (which may also be perpendicular or normal to the horizon), and an x-axis (e.g., left to right in the image) may be parallel with the Earth's horizon. In other examples, a reference orientation may correspond to another orientation, for instance with respect to a reference object that may define a reference axis. In such examples, when an image aligns with the reference orientation, an x-axis and/or y-axis of the image may be parallel or perpendicular to the reference axis indicated by the reference orientation.

The systems described herein may perform step 520 in a variety of ways. In one example, determining the reference orientation may further include saving orientation data from an IMU of the device when capturing the image data, deriving a global reference from the orientation data, and determining the reference orientation from the global reference. For example, wearable device 400 may save orientation data from the IMU when capturing captured images 600 and/or 700. The orientation data may indicate an orientation of wearable device 400 when captured images 600 and/or 700 were captured. Because the IMU may determine the orientation data with respect to a global reference, such as gravity, wearable device 400 may use the orientation data to derive the global reference and determine the reference orientation from the global reference. The orientation data from the IMU may indicate an offset of wearable device 400 from being level (e.g., aligned with the global reference).

In some examples, determining the reference orientation may further include recognizing an object in the captured image data, deriving orientation data from the recognized object, and determining the reference orientation from the orientation data. For example, wearable device 400 may recognize an object in captured images 600 and/or 700. The recognized object may be a face. Wearable device 400 may determine a pose data of the recognized face to determine the orientation data. The pose data may define a reference axis corresponding to the recognized face. The reference orientation may correspond to the reference axis associated with the recognized face. The reference axis may further correspond to a desired axis for captured image data, such as a positive y-axis direction.

In other examples, the recognized object may be, for instance, a background object, such as walls, corners, doors, windows, etc., which may define a discernable reference axis (e.g., an axis tracing a substantially straight edge of the object, an axis defined between two or more recognized reference points of the object, etc.). Wearable device 400 may derive the orientation data from the reference axis and further determine the reference orientation from the reference axis.

In some examples, a user input may define, at least in part, the reference orientation. For instance, the user may be presented with options choosing between using IMU data, face recognition (which may include selecting from one or more recognized faces in the captured image data), selecting an object, etc. In some examples, the user may be presented with a manual assist feature, for instance allowing the user to manually define a desired reference axis from possible reference axis options (e.g., from IMU data, recognized objects, etc.) and/or manually input the desired reference axis (e.g., by drawing the desired reference axis).

At step 530, one or more of the systems described herein may rotate the captured image data based on the reference orientation. For example, wearable device 400 may rotate captured images 600 and/or 700 based on the reference orientation.

The systems described herein may perform step 530 in a variety of ways. In one example, rotating the captured image data may further include rotating the captured image data to align (e.g., make parallel with) the reference orientation with an x-axis or y-axis of the image data. For example, if the reference orientation corresponds to a direction of gravity, wearable device 400 may rotate the captured image data to align a negative y-axis of the captured image data with the direction of gravity. If the reference orientation corresponds to a horizon (e.g., an axis perpendicular to the direction of gravity), wearable device 400 may rotate the captured image data to align an x-axis of the captured image data with the horizon. In some examples, orientation from the IMU may indicate an offset of wearable device 400 from a global reference (e.g., direction of gravity, horizon, etc.) such that a similar offset may be applied for rotating the captured image data.

In some examples, if the reference orientation corresponds to a reference axis defined by an object, wearable device 400 may rotate the captured image data to align with the reference axis. For instance, if the reference axis corresponds to a positive y-axis, wearable device 400 may rotate the captured image data such that a positive y-axis of the image data aligns with the reference axis.

FIG. 6B illustrates a rotated image 610 that shows captured image 600 rotated based on a reference orientation derived from IMU data (e.g., horizon leveling). FIG. 6C illustrates a rotated image 620 that shows captured image 600 rotated based on a reference orientation derived from face recognition (e.g., portrait leveling). As seen in FIG. 6B, by rotating captured image 600 based on IMU data, background objects such as walls and corners are seen aligned with a direction of gravity (e.g., a downward direction in rotated image 610 is parallel with an expected direction of gravity when viewing rotated image 610). As seen in FIG. 6C, by rotating captured image 600 based on face recognition, the user's face is seen aligned with a y-axis of rotated image 620 such that the user's face is presented upright. Because the user's face generally aligns with the direction of gravity in captured image 600, the rotations produced from horizon leveling (e.g., rotated image 610) and portrait leveling (e.g., rotated image 620) may produce similar results.

FIG. 7B illustrates a rotated image 710 that shows captured image 700 rotated based on a reference orientation derived from IMU data (e.g., horizon leveling). FIG. 7C illustrates a rotated image 720 that shows captured image 700 rotated based on a reference orientation derived from face recognition (e.g., portrait leveling). As seen in FIG. 7B, by rotating captured image 700 based on IMU data, background objects such as walls and corners are seen aligned with a direction of gravity (e.g., a downward direction in rotated image 710 is parallel with an expected direction of gravity when viewing rotated image 710). As seen in FIG. 7C, by rotating captured image 700 based on face recognition, the user's face is seen aligned with a y-axis of rotated image 720 such that the user's face is presented upright. However, because the user's face is not aligned with the direction of gravity in captured image 700, the background objects (e.g., door, walls, corners, etc.) may not be aligned with the direction of gravity. Accordingly, the rotations produced from horizon leveling (e.g., rotated image 710) and portrait leveling (e.g., rotated image 720) may produce different results. The user may prefer and select one option over the other.

Moreover, as seen in rotated images 610, 620, 710, and 720, rotating captured images 600 and 700 may produce portions without image data. Because image data may be stored and/or displayed in a two-dimensional rectangular format, rotating such image data within the rectangular format may produce portions missing image data. To remove these portions of missing image data, wearable device 400 may enlarge (e.g., zoom in) and/or crop the rotated image data.

In some examples, wearable device 400 may automatically perform enlarging and/or cropping. For example, wearable device 400 may determine an optimal resolution, such as a maximum resolution that may minimize an amount of cropped data, or optimizing to minimize cropping of recognized objects. Wearable device 400 may automatically perform enlarging and/or cropping based on user preferences that may define a desired optimization. In other examples, wearable device 400 may present the user an interface to manually enlarge and/or crop the rotated image data.

As illustrated in FIG. 5, at step 540 one or more of the systems described herein may store the rotated image data. For example, wearable device 400 may save the rotated image data.

The systems described herein may perform step 540 in a variety of ways. In one example, wearable device 400 may save the rotated image data in a local storage and/or a local buffer. In some examples, wearable device 400 may transfer (e.g., via a wired or wireless network) the rotated image data to another computing device.

Although the above example refers to photographs, in other examples, the concepts described herein may be applied to other types of image data, such as video. For instance, the systems and methods described herein may be applied to each frame of a video.

Wearable devices, such as smartwatches, may allow the user to take photographs, such as self-portrait (e.g., “selfie”) photographs. However, due to the placement of the wearable device on a user's body, and the user's natural body movements, the user may have difficulty taking level photographs with the wearable device. For example, the user may find it awkward or otherwise difficult to hold their arm level to the horizon when taking a selfie. By using inputs that may already be available with the wearable device, such as IMU measurements, facial recognition, etc., the user may be provided options for adjusting or correcting any unwanted tilt that may be due to the user's tilted arm when taking the selfie. For example, by using the wearable device's IMU data, the tilt in the device may be countered by accordingly rotating the associated photo. Alternatively, by recognizing a facial pose in the photo, the photo may be rotated to present the face in an upright orientation. Thus, the systems and methods described herein may efficiently provide corrections to tilted photos without requiring additional hardware.

### EXAMPLE EMBODIMENTS

Example 2: A device comprising: an optical sensor; at least one physical processor; and physical memory comprising computer-executable instructions that, when executed by the physical processor, cause the physical processor to: capture, using the optical sensor, image data; determine a reference orientation associated with the captured image data; rotate the captured image data based on the reference orientation; and store the rotated image data.

Example 3: The device of Example 2, further comprising an inertial measurement unit (IMU), wherein the instructions for determining the reference orientation further comprises instructions for: saving orientation data from the IMU when capturing the image data; deriving a global reference from the orientation data; and determining the reference orientation from the global reference.

Example 4: The device of Examples 2 or 3, wherein the instructions for determining the reference orientation further comprises instructions for: recognizing an object in the captured image data; deriving orientation data from the recognized object; and determining the reference orientation from the orientation data.

Example 5: The device of any of Examples 2-4, wherein the recognized object corresponds to a face and the orientation data corresponds to pose data of the face.

Example 6: The device of any of Examples 2-5, wherein the instructions further comprise instructions for enlarging the rotated image data.

Example 7: The device of any of Examples 2-6, wherein the instructions further comprise instructions for cropping the rotated imaged data.

Example 8: The device of any of Examples 2-7, wherein the instructions for rotating the captured image data further comprise instructions for rotating the captured image data to align the reference orientation with an x-axis or y-axis of the image data.

Example 9: A computer-implemented method comprising: capturing, using an optical sensor, image data; determining a reference orientation associated with the captured image data; rotating the captured image data based on the reference orientation; and storing the rotated image data.

Example 10: The method of Example 9, wherein determining the reference orientation further comprises: saving orientation data from an inertial measurement unit (IMU) when capturing the image data; deriving a global reference from the orientation data; and determining the reference orientation from the global reference.

Example 11: The method of Examples 9 or 10, wherein determining the reference orientation further comprises: recognizing an object in the captured image data; deriving orientation data from the recognized object; and determining the reference orientation from the orientation data.

Example 12: The method of any of Examples 9-11, wherein the recognized object corresponds to a face and the orientation data corresponds to pose data of the face.

Example 13: The method of any of Examples 9-12, further comprising enlarging the rotated image data.

Example 14: The method of any of Examples 9-13, further comprising cropping the rotated imaged data.

Example 15: The method of any of Examples 9-14, wherein rotating the captured image data further comprises rotating the captured image data to align the reference orientation with an x-axis or y-axis of the image data.

Example 16: A non-transitory computer-readable medium comprising one or more computer-executable instructions that, when executed by at least one processor of a computing device, cause the computing device to: capture, using an optical sensor of the computing device, image data; determine a reference orientation associated with the captured image data; rotate the captured image data based on the reference orientation; and store the rotated image data.

Example 17: The computer-readable medium of Example 16, wherein the instructions for determining the reference orientation further comprises instructions for: saving orientation data from an inertial measurement unit (IMU) of the computing device when capturing the image data; deriving a global reference from the orientation data; and determining the reference orientation from the global reference.

Example 18: The computer-readable medium of Examples 16 or 17, wherein the instructions for determining the reference orientation further comprises instructions for: recognizing an object in the captured image data; deriving orientation data from the recognized object; and determining the reference orientation from the orientation data.

Example 19: The device of any of Examples 16-18, wherein the recognized object corresponds to a face and the orientation data corresponds to pose data of the face.

Example 20: The device of any of Examples 16-19, wherein the instructions further comprise instructions for enlarging the rotated image data.

Example 21: The device of any of Examples 16-20, wherein the instructions further comprise instructions for cropping the rotated imaged data.

Example 22: The device of any of Examples 16-21, wherein the instructions for rotating the captured image data further comprise instructions for rotating the captured image data to align the reference orientation with an x-axis or y-axis of the image data.

### Example Methods, Systems, and Devices for Batch Message Transfer

Wearable devices may be configured to be worn on a user's body part, such as a user's wrist, arm, leg, torso, neck, head, finger, etc. Such wearable devices may be configured to perform various functions. For example, a wristband system may be an electronic device worn on a user's wrist that performs functions such as delivering content to the user, executing social media applications, executing artificial-reality applications, messaging, web browsing, sensing ambient conditions, interfacing with head-mounted displays, monitoring a health status of the user, etc. However, the compact size of wearable devices may restrict the physical dimensions and/or energy capacity of batteries that supply power to the processors, sensors, and actuators of wearable devices.

The present disclosure details systems, devices, and methods related to conserving power consumption in wearable devices (e.g., a smartwatch, smart eyeglasses, a head-mounted display, etc.) in order to extend the amount of time before battery charging is required. Many of the functions of the wearable device may require wireless communications to exchange data with other devices, smartphones, access points, servers, etc. In some examples, a wireless communication unit in a wearable device may be placed in a low-power mode to conserve battery power. The wireless communication unit may be configured to not receive messages from other devices while in the low-power mode (e.g., a sleep mode). Messages intended for receipt by the wearable device may be temporarily stored in memory by another device (e.g., a smartphone of the user of the wearable device, a gateway device, etc.). The stored messages may be sent to the wearable device as a batch of messages when the wireless communication unit is configured to a normal operating mode (e.g., woken from the low-power mode). Advantages of embodiments of the present disclosure may include reducing power consumption in the wearable device and extending the amount of time the wearable device may be used before requiring a battery recharge.

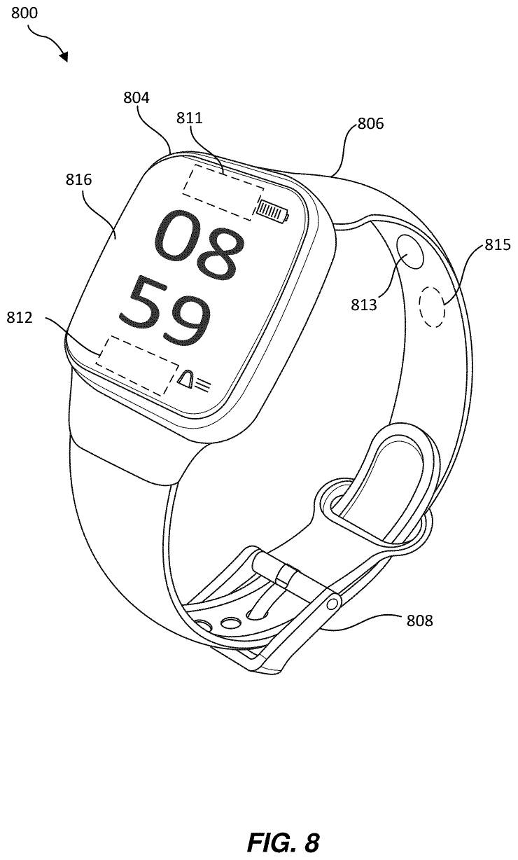

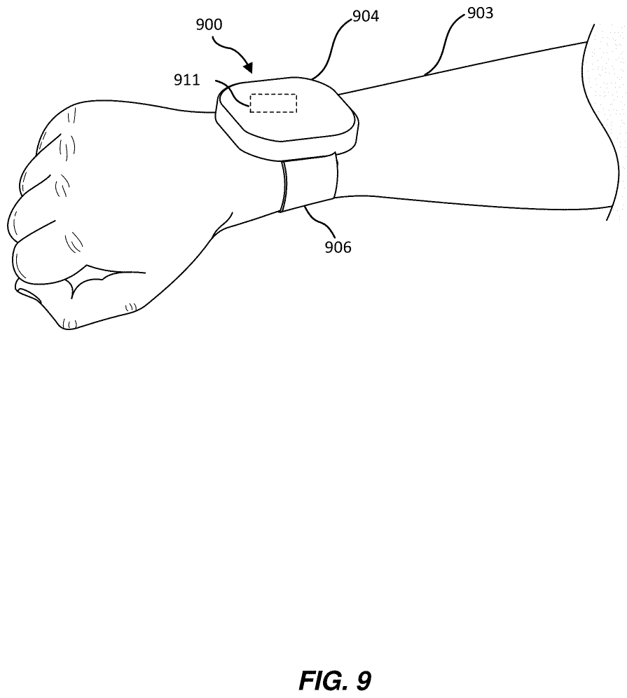

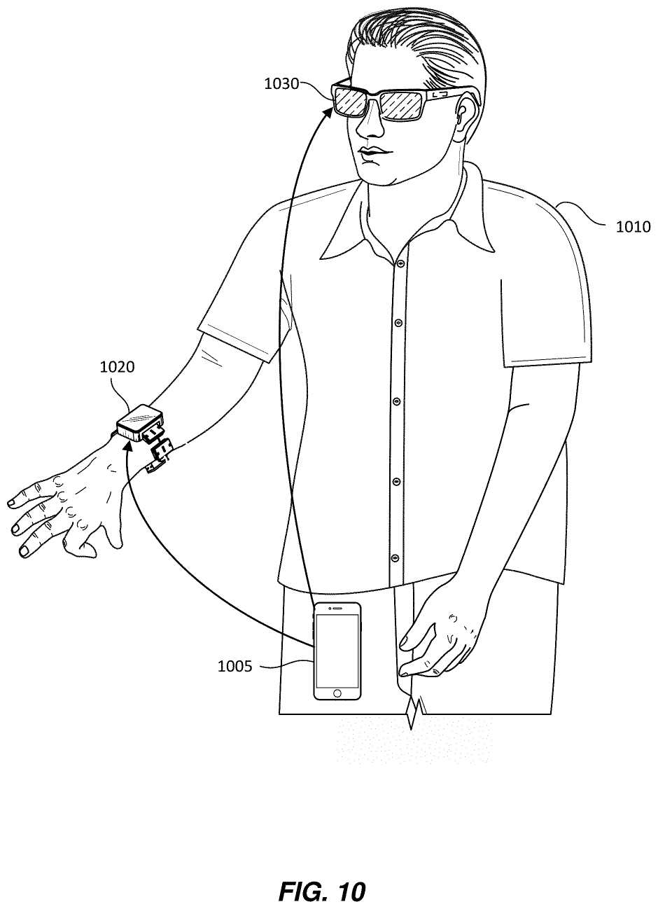

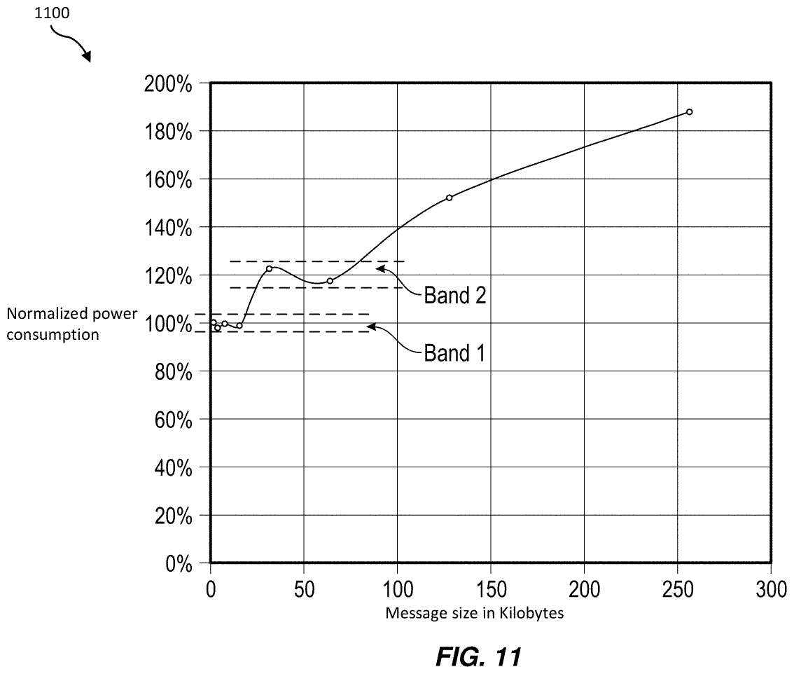

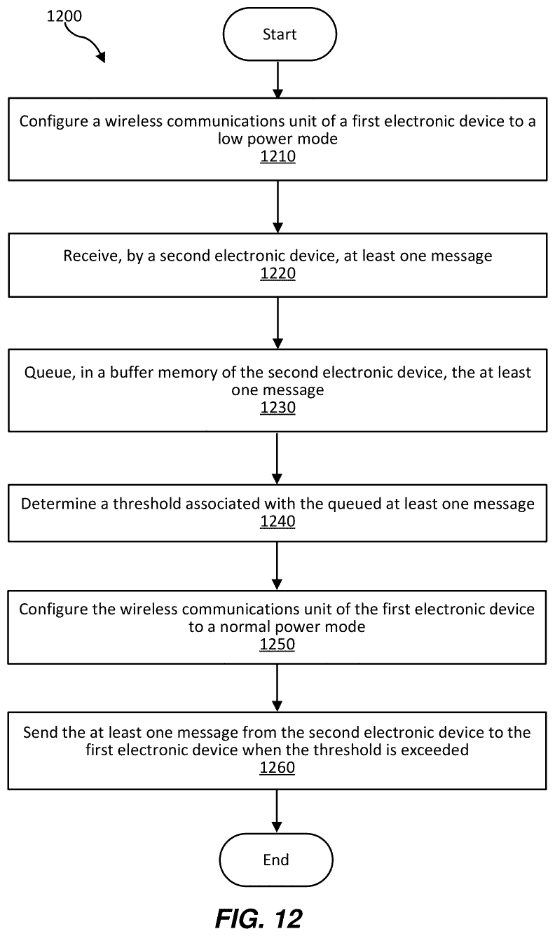

The following will provide, with reference to FIGS. 8-12, detailed descriptions of methods, systems, and devices for batch message transfer to reduce battery power consumption in an electronic device with limited battery capacity (e.g., a wearable device). First, a description of a wristband system with limited battery capacity is presented with reference to FIG. 8. A description of a user donning a wearable device with limited battery capacity is presented with reference to FIG. 9. A description of a device (e.g., a smartphone) transferring batch messages to wearable devices is presented with reference to FIG. 10. A chart illustrating normalized power consumption of a wireless communications unit as a function of aggregate message size is presented with reference to FIG. 11. A flowchart of a method of reducing power consumption in a wireless communications unit by batch messaging is presented with reference to FIG. 12.

FIG. 8 illustrates a perspective view of an example wearable device in the form of a smartwatch 800. Smartwatch 800 may have a substantially rectangular or circular shape and may be configured to allow a user to wear smartwatch 800 on a body part (e.g., a wrist). Smartwatch 800 may include a retaining mechanism 808 (e.g., a buckle, a hook and loop fastener, etc.) for securing watch band 806 to the user's wrist.

Smartwatch 800 may be configured to execute functions, such as, without limitation, sending/receiving messages (e.g., text, speech, images, video, etc.), displaying messages, configuring user preferences, displaying visual content to the user (e.g., visual content displayed on display screen 816), sensing user input, messaging, capturing images, determining location, performing financial transactions, providing haptic feedback, performing wireless communications (e.g., Long Term Evolution (LTE), cellular, near field, wireless fidelity (WiFi), Bluetooth™ (BT), personal area network, 4G, 5G, 6G), etc. Smartwatch 800 may include a wireless communications unit 812 configured to perform wireless communications including transmitting and/or receiving messages. Wireless communications unit 812 and the other circuits within smartwatch 800 may be powered by battery 811. Battery 811 may have limited capacity due to the limited physical dimensions of smartwatch 800.

In order to reduce power consumption in battery 811, wireless communication unit 812 may be placed in a low-power mode. Wireless communication unit 812 may be configured to not receive messages from other devices while in the low-power mode (e.g., a sleep mode). Messages intended for receipt by smartwatch 800 may be temporarily stored (e.g., accumulated) in memory by another device (e.g., a companion device such as a smartphone of the user of smartwatch 800). The stored messages may be sent smartwatch 800 as a batch of messages when wireless communication unit 812 is configured to a normal operating mode. Smartwatch 800 may include a user interface that allows the user to configure parameters related to receiving messages. For example, the user may be able to select a low-power mode in which messages are accumulated or a normal mode in which messages are individually received by smartwatch 800. In addition, the user may also be able to select an option in which certain messages that are indicated to have high priority (e.g., based on the message sender, the time of day, the subject matter, etc.) may be delivered to smartwatch 800 without the delay associated with accumulating the messages in another device.

Smartwatch 800 may be configured to be worn by a user such that an inner surface of watch band 806 and/or an inner surface of watch body 804 may be adjacent to (e.g., in contact with) the user's skin. Watch band 806 may include multiple sensors 813, 815 that may be distributed on an inside and/or an outside surface of watch band 806. Sensors 813, 815 may include one or more biosensors configured to sense a user's heart rate, saturated oxygen level, temperature, sweat level, muscle intentions, or a combination thereof.

Additionally or alternatively, watch body 804 may include the same or different sensors than watch band 806. For example, multiple sensors may be distributed on an inside and/or an outside surface of watch body 804. Watch body 804 may include, without limitation, a proximity sensor, a front facing image sensor, a rear-facing image sensor, a biometric sensor, an inertial measurement unit, a heart rate sensor, a saturated oxygen sensor, a neuromuscular sensor, an altimeter sensor, a temperature sensor, a bioimpedance sensor, a pedometer sensor, an optical sensor, a touch sensor, a sweat sensor, or any combination or subset thereof. Watch body 804 may also include a sensor that provides data about a user's environment, such as a user's motion (e.g., with an inertial measurement unit), altitude, location, orientation, gait, or a combination thereof.

Watch band 806 and/or watch body 804 may include a haptic device (e.g., a vibratory haptic actuator) that is configured to provide haptic feedback (e.g., a cutaneous and/or kinesthetic sensation, etc.) to the user's skin. The sensors and/or haptic devices may be configured to operate in conjunction with multiple applications including, without limitation, health monitoring, social media, game playing, and artificial reality.

FIG. 9 is a perspective view of a user wearing a wristband system 900, according to at least one embodiment of the present disclosure. A user may wear wristband system 900 on any body part. For example, a user may wear wristband system 900 on a forearm 903. The wristband system may include a watch body 904 and a wristband 906 for securing the watch body 904 to the user's forearm 903. Watch body 904 may include a wireless communication unit 911 for communicating with another device.

FIG. 10 illustrates a device 1005 (e.g., a smartphone) configured to transfer messages to wearable devices including smartwatch 1020 and/or smart eyeglasses 1030, according to at least one embodiment of the present disclosure. Smartwatch 1020 and/or smart eyeglasses 1030 may be configured to be worn by user 1010 in order to provide content and/or messages to user 1010. Smartwatch 1020 and/or smart eyeglasses 1030 may be configured as compact devices with limited battery capacity. For example, battery capacity in smartwatch 1020 and/or smart eyeglasses 1030 may be limited to under 500 mAH, under 400 mAH, under 300 mAH, under 200 mAH, or less. Smartwatch 1020 and/or smart eyeglasses 1030 may be configured to conserve battery power by configuring a wireless communications unit in smartwatch 1020 and/or smart eyeglasses 1030 into a low-power mode.

In some examples, device 1005 may be configured to accumulate messages intended for smartwatch 1020 and/or smart eyeglasses 1030 in a memory (e.g., a buffer memory) until a threshold associated with the accumulated messages is reached. Once the threshold is reached or exceeded, the wireless communications unit in smartwatch 1020 and/or smart eyeglasses 1030 may switch to a normal-power mode and receive the accumulated messages sent by device 1005. Smartwatch 1020 and/or smart eyeglasses 1030 may communicate wirelessly with device 1005 using communications protocols including, without limitation, WiFi, Bluetooth™, near field, cellular, 4G, 5G, 6G, infrared, or a combination thereof.

Although FIG. 10 shows the wearable device configured as smartwatch 1020 and smart eyeglasses 1030, the present disclosure is not so limited, and the wearable device may include any type of wearable device capable of receiving messages from another device or a communications network. Further, although FIG. 10 shows device 1005 configured as a smartphone, the present disclosure is not so limited and device 1005 may include any device capable of accumulating messages until a threshold is reached or exceeded and sending the accumulated messages to smartwatch 1020 and/or smart eyeglasses 1030. For example, device 1005 may include a laptop, a tablet, an access point, a server, a base station, a router, etc.

FIG. 11 is a chart 1100 illustrating example normalized power consumption of a wireless communications unit as a function of message size, according to at least one embodiment of the present disclosure. A wireless communication unit in a limited battery capacity device (e.g., a wearable device) may be configured to consume battery power when receiving data (e.g., a message). In some examples, the wireless communication unit may be configured to consume the same amount of battery power when receiving small amounts of data as when receiving larger amounts of data due to the overhead required by the wireless communication unit circuits and/or the communications protocol used to receive the data. Messages containing small amounts of data may require a minimum amount of battery power consumption. For example, referring to chart 1100, power consumption band 1 may include a range of data sizes in which substantially the same amount of power is required. Band 1 may include data sizes from about 1 byte to about 2K bytes, from about 2K bytes to about 4K bytes, from about 4K bytes to about 8K bytes, from about 8K bytes to about 16K bytes, or more. Power consumption band 2 may include a range of data sizes in which substantially the same amount of power is required. Power consumption band 2 may require more battery power than band 1. As shown in FIG. 11, band 2 may require about 20% more battery power than band 1. Since the same amount of battery power may be required for different sized messages up to a threshold, battery power may be conserved by accumulating multiple messages up to an aggregate threshold and sending the accumulated messages to the wearable device in a batch. By doing so, the receipt of the accumulated messages by the wearable device may require less power than separately receiving each message.

In some embodiments, the wearable device and/or the device from which the wearable device receives messages may include a user interface configured for allowing the user to select between different message receipt modes. For example, the user may be able to select a low-power mode in which messages are accumulated as described above or a normal or high-power mode in which messages are individually received by the wearable device. In addition, the user may also be able to select an option in which certain messages that are indicated to have high importance (e.g., from a certain individual, at a certain time of day, dealing with important subject matter, including certain words, etc.) may be delivered to the wearable device without waiting to reach the aggregate threshold.

FIG. 12 is flowchart of a method 1200 of reducing power consumption in a wireless communications unit by batch messaging, according to at least one embodiment of the present disclosure. At operation 1210, method 1200 may include configuring a wireless communications unit of a first electronic device to a low-power mode. Operation 1210 may be performed in a variety of ways, as will be understood by one skilled in the art considering the present disclosure. For example, configuring a wireless communications unit of an electronic device (e.g., smartwatch 1020 and/or smart eyeglasses 1030 of FIG. 10) to a low-power mode may include sending a low power command to the wireless communications unit, reducing the supply voltage of the wireless communications unit, reducing a clock speed, gating a clock, or a combination thereof. In some examples, a wireless communications unit may enter a low-power mode by only receiving certain control messages (e.g., a control channel, a WiFi beacon frame, etc.).

At operation 1220, method 1200 may include receiving, by a second electronic device, at least one message. Operation 1220 may be performed in a variety of ways, as will be understood by one skilled in the art considering the present disclosure. For example, a second electronic device (e.g., a smartphone, device 1005 of FIG. 10, etc.) may be configured as a gateway device to receive messages intended for the wearable device, accumulate the messages, and send the messages to the wearable device.

At operation 1230, method 1200 may include queuing, in a buffer memory of the second electronic device, the at least one message. Operation 1230 may be performed in a variety of ways, as will be understood by one skilled in the art considering the present disclosure. For example, a second electronic device (e.g., a smartphone, device 1005 of FIG. 10, etc.) may receive messages intended for the wearable device, accumulate the messages and store the messages. The messages may be stored in a buffer memory (e.g., a cache, a first-in first-out buffer, etc.).

At operation 1240, method 1200 may include determining a threshold associated with the queued at least one message. Operation 1240 may be performed in a variety of ways, as will be understood by one skilled in the art considering the present disclosure. For example, a threshold for accumulated messages may be determined based on a determining a power consumption band (e.g., band 1 and/or band 2 of FIG. 4) in which the power consumed by the wireless communications unit uses substantially the same amount of power for a range of message sizes. In some examples, the threshold may be an aggregate size of the accumulated messages (e.g., 8k bytes, 16K, bytes, 32K bytes, etc.), an aggregate number of individual messages, a time period, or a combination thereof.

At operation 1250, method 1200 may include configuring the wireless communications unit of the first electronic device to a normal-power mode. Operation 1250 may be performed in a variety of ways, as will be understood by one skilled in the art considering the present disclosure. For example, a wireless communications unit of a device (e.g., a smartphone, device 1005 of FIG. 10, etc.) may switch from a low-power mode to a normal operating power mode based on a timer, receiving a control message through a control channel, interpreting a reserved control bit in a beacon frame, etc.

At operation 1260, method 1200 may include sending the at least one message from the second electronic device to the first electronic device when the threshold is exceeded. Operation 1260 may be performed in a variety of ways, as will be understood by one skilled in the art considering the present disclosure. For example, a device (e.g., a smartphone, device 1005 of FIG. 10, etc.) may send accumulated messages to a wearable device (e.g., smartwatch 1020 and/or smart eyeglasses 1030 of FIG. 10) when the threshold is reached or exceeded. In some examples, the device may begin to accumulate new messages after sending the previously accumulated messages. In some examples, the device may be configured to bypass the step of accumulating a message when that message has been determined to have a high delivery priority. For example, a user may set preferences for prioritizing messages based on an attribute of the message (e.g., the identity of the message sender, a time of day, a type of message, etc.). In some examples, a prioritized message may not be placed in the message accumulation buffer and may be sent to the wearable device right after being received by the device. In additional embodiments, the selection of the low-power mode may not be required. Rather, the second electronic device may be configured to accumulate messages until the threshold is reached regardless of a power mode of the first electronic device.

As described in detail above, systems, devices, and methods of the present disclosure may conserve battery power in wearable devices (e.g., a smartwatch, smart eyeglasses, a head-mounted display, etc.) in order to extend the amount of time before battery charging is required. Many of the functions of the wearable device may require wireless communications to exchange data with other devices, smartphones, access points, servers, etc. In some examples, a wireless communication unit in a wearable device may be placed in a low-power mode to conserve battery power. The wireless communication unit may be configured to not receive messages from other devices while in the low-power mode (e.g., a sleep mode). Messages intended for receipt by the wearable device may be temporarily stored in memory by another device (e.g., a smartphone of the user of the wearable device). The stored messages may be sent to the wearable device as a batch of messages when the wireless communication unit is configured to a normal operating mode (e.g., woken from the low-power mode). Advantages of embodiments of the present disclosure may include reducing power consumption in the wearable device and extending the amount of time the wearable device may be used before requiring a battery recharge.

### EXAMPLE EMBODIMENTS

Example 23: A method may include configuring a wireless communications unit of a first electronic device to a low power mode, receiving, by a second electronic device, at least one message, queuing, in a buffer memory of the second electronic device, the at least one message, determining a threshold associated with the queued at least one message, configuring the wireless communications unit of the first electronic device to a normal power mode, and sending the at least one message from the second electronic device to the first electronic device when the threshold is exceeded.

Example 24: The method of Example 23, wherein the second electronic device comprises at least one of a smartphone, a laptop, a tablet, an access point, or a router.

Example 25: The method of Example 23 or Example 24, wherein the first electronic device comprises a wearable device.

Example 26: The method of any of Examples 23-25, wherein the wearable device comprises a smartwatch.

Example 27: The method of any of Examples 23-26, wherein the wearable device comprises a head-mounted display.

Example 28: The method of any of Examples 23-27, wherein the wearable device comprises smart eyeglasses.

Example 29: The method of any of Examples 23-28, wherein the threshold associated with the queued at least one message comprises a memory size threshold.

Example 30: The method of any of E Examples 23-29, wherein the threshold associated with the queued at least one message comprises a number of queued messages.

Example 31: The method of any of Examples 23-30, wherein the threshold associated with the queued at least one message comprises a priority class associated with a source of the at least one message.

### Example Systems and Methods for E911 Call Support for Mobile Computing Devices

The 911 universal emergency service may be an important part of an emergency response and disaster preparedness system. Enhanced 911 (E911) may automatically report a telephone number and a location of a 911 call made from a phone. For example, wired carriers may provide E911 service for landline phones. In other examples, E911 service may be provided as a Voice over Internet Protocol (VoIP) service and/or as a mobile satellite service.

In addition, or in the alternative, wireless telephone carriers may provide E911 service capabilities for wireless 911 calls originating from mobile computing devices (e.g., mobile phones, a cell phones, smartwatches, wearable computing devices, etc.). In some cases, the wireless telephone carrier may provide a Public Safety Answering Point (PSAP) (e.g., a 911 dispatcher in a call center) with the telephone number of the originator of a wireless 911 call and the location of a cell site or base station that may be transmitting the call. In other cases, the wireless carrier may provide the PSAP with the telephone number of the originator of the wireless 911 call and the location of the mobile computing device that may be placing the call. For example, placing a E911 call from a mobile computing device may include the wireless carrier receiving the telephone number of the mobile computing device and the Global Positioning System (GPS) location of the mobile computing device (e.g., latitude and longitude coordinates) while the user of the mobile computing device is speaking with a 911 dispatcher. Incorporating E911 service capabilities into mobile computing devices that may provide both the telephone number and location of a mobile computing device that is placing the E911 call may provide a PSAP with valuable information for the timely response to the E911 call.

In some implementations, providing accurate emergency services in a mobile computing device that maximizes data transmission rates and voice quality while preserving battery power may be challenging. This may be especially challenging in a wearable mobile computing device that may have a small form factor. These small form factor wearable mobile computing devices may also have subpar or less than optimal radio frequency (RF) antenna coverage due, at least in part, to a reduction in the overall performance of the RF antenna based on the need for a smaller form factor RF antenna for incorporating into the wearable computing device. In some implementations, the RF antenna may be implemented using multiple antennae.

In many cases, for an E911 service to be effective the transmission of voice data (e.g., audio data) and digital data (e.g., location data) should occur simultaneously. Lack of either type of data and/or a degradation in the transmission of either type of data may jeopardize the accuracy and/or the response to the E911 emergency service. For example, the mobile computing device may place an E911 call that a communication carrier may complete using Long-Term Evolution (LTE) wireless broadband communications. The LTE communications may support a data bearer along with a Voice over LTE (VoLTE) bearer. In some situations, however, simultaneously transmitting the LTE data bearer along with the VoLTE bearer may degrade the voice quality of the transmission which may severely impact a user experience. Yet disallowing transmission of digital data (e.g., the data bearer) during an E911 service, while aimed at improving the voice quality of the transmission, could be detrimental to the accuracy of any possible estimates of the location of the mobile computing device. For example, for E911 services implemented to receive secure user plane location (SUPL) based location data as digitally transmitted data, disallowing any type of digital data transmission (e.g., the data bearer) while on a VoLTE call could adversely impact the accuracy of location estimates for the mobile computing device initiating the call. In addition, or in the alternative, the mobile computing device providing simultaneous voice data and digital data transmission may cause other applications running on the mobile computing device to also utilize the data bearer for the transmission, which may cause additional degradation of the VoLTE transmission.

Because the operating system running on the mobile computing device may initiate and implement the E911 service, the operating system may also block other applications from utilizing the data bearer during the E911 service transmission. This may allow the E911 service transmission to receive and provide location information for the mobile computing device along with the voice data with little to no degradation of any of the data. For example, a call manager (CM) object in the operating system may use a session internet protocol (SIP) INVITE message with SOS along with an Emergency access point name (APN) when implementing the E911 emergency service. The CM may then trigger a network data stack to receive SUPL information for an LTE Positioning Protocol (LPP) process, while blocking all other applications that may also utilize the data bearer such as, for example, PUSH services, streaming services, and/or messenger services that may be running on the mobile computing device. Blocking these other applications by the network stack within the operating system of the mobile computing device while providing the E911 emergency service to a user of the mobile computing device may significantly improve the E911 user emergency service experience.

The present disclosure is generally directed to systems and methods for E911 call support for mobile computing devices. As will be explained in greater detail below, embodiments of the present disclosure may include a mobile computing device that receives an indication to initiate a voice call by a user of the mobile computing device, determines that the voice call is an emergency voice call, initiates an Internet Protocol Multimedia Subsystem (IMS) emergency call based on determining that the voice call is an emergency voice call, and for a duration of the IMS emergency call, receives location data for the user while providing a voice service for the IMS emergency call, and blocks at least one data service to at least one application executing on the mobile computing device. Blocking at least one data service to at least one application executing on a mobile computing device by the network stack within the operating system of the mobile computing device while providing an E911 emergency service to a user of the mobile computing device may significantly improve the E911 user emergency service experience. The improved user experience is based on the real time implementation of an E911 service in the mobile computing device that provides simultaneous transmission of voice data and digital data, providing a PSAP with valuable and accurate information for executing a timely and location-accurate response to the E911 service call.

Features from any of the embodiments described herein may be used in combination with one another in accordance with the general principles described herein. These and other embodiments, features, and advantages will be more fully understood upon reading the following detailed description in conjunction with the accompanying drawings and claims.

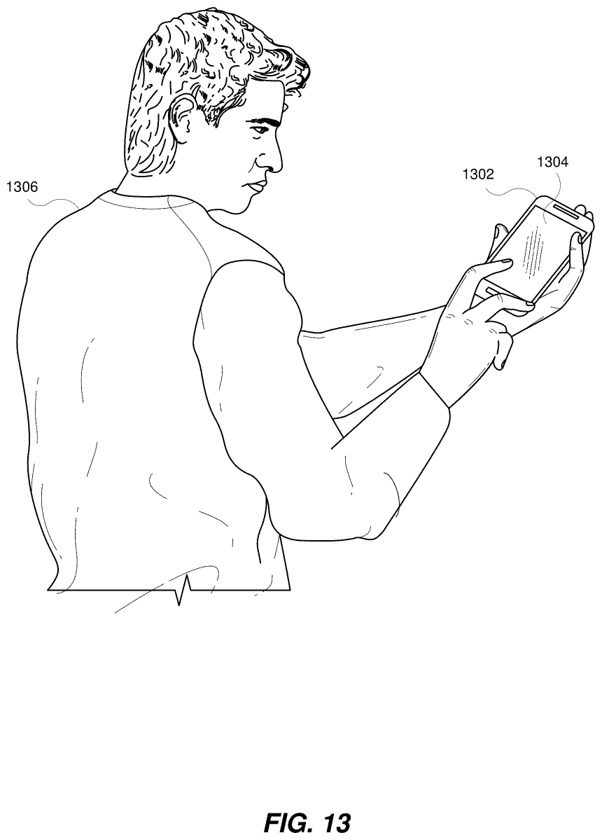

The following will provide, with reference to FIGS. 13-17, detailed descriptions for placing E911 service calls on mobile computing devices where the E911 service transmission may receive and provide location information for the mobile computing device along with the voice data with little to no degradation in the transmission of any of the data.

FIG. 13 is an illustration of a user 1306 interacting with a mobile computing device 1302 capable of placing E911 service calls. The user 1306 may be initiating or placing an E911 call on the mobile computing device 1302. For example, the user 1306 may interact or interface with a touchscreen 1304 of the mobile computing device 1302 to initiate the call. In another example, the user 1306 may interface or interact with the mobile computing device 1302 using one or more voice commands to initiate the E911 call.

An example of a wearable mobile computing device may be the smartwatch 800, as shown in FIG. 8. The smartwatch 800 may allow a user (e.g., the user 1010 as shown in FIG. 10) to wear the smartwatch 800 on a body part (e.g., a wrist as shown in FIG. 9 and FIG. 10). The smartwatch 800 may execute functions that enable the smartwatch 800 to provide E911 service calls. These functions may include, but are not limited to, determining a location of the smartwatch 800 and performing wireless communications (e.g., LTE, VoLTE, cellular, near field, wireless fidelity (WiFi), Bluetooth™ (BT), personal area network, 4G, 5G, 6G, etc.). The wireless communications unit 812 may perform wireless communications including transmitting and/or receiving messages. The battery 811 may power the wireless communications unit 812 and the other circuits within the smartwatch 800 (e.g., a GPS location unit). In some implementations, the battery 811 may have limited capacity due to the limited physical dimensions of the smartwatch 800.

As shown in FIG. 10, the device 1005 (e.g., a smartphone, a mobile computing device) may communicate with wearable devices such as a smartwatch 1020 and/or smart eyeglasses 1030 that are worn by the user 1010. The smartwatch 1020 and/or the smart eyeglasses 1030 may communicate wirelessly with the device 1005 using communications protocols including, without limitation, WiFi, Bluetooth™, near field, cellular, 4G, 5G, 6G, infrared, or a combination thereof. The user 1010 interacting with the smartwatch 1020 and/or the smart eyeglasses 1030 may initiate an E911 call. In some implementations, the smartwatch 1020 and/or the smart eyeglasses 1030 may interface (communicate) with the device 1005 for the placement of the E911 call.

In another example, an augmented-reality system may include the capability to transmit E911 service calls. A microphone array with the acoustic transducers may convert detected sounds (e.g., the voice of a user) into an electronic format (e.g., voice data). The augmented-reality system may be paired or connected to another computing device that may provide battery and computational power to support the E911 service call. A user, therefore, may utter voice commands that the acoustic transducers may pick up and convert to the voice data. In addition, the paired computing device and/or the augmented-reality system may provide location data for the augmented-reality system. In another example, a haptic device may include the capability to transmit E911 service calls. The haptic device may include a touchscreen that the user may interface or interact with to place an E911 call. In another example, the user may use one or more voice commands to initiate the E911 call on the haptic device.

Though FIGS. 8, 9, and 10 show some examples of wearable mobile computing devices (e.g., the smartwatch 800, the wristband system 900, the smartwatch 1020, the smart eyeglasses 1030), there are many other types of wearable mobile computing devices that may be capable of providing E911 service calls. These wearable mobile computing devices may include devices of the Internet of Things. Other examples of wearable mobile computing devices that may be capable of providing E911 service calls may include, but are not limited to, fitness trackers and, as described herein, head-mounted display devices, head-mounted display glasses, virtual reality headsets or glasses, and augmented reality headsets or glasses.

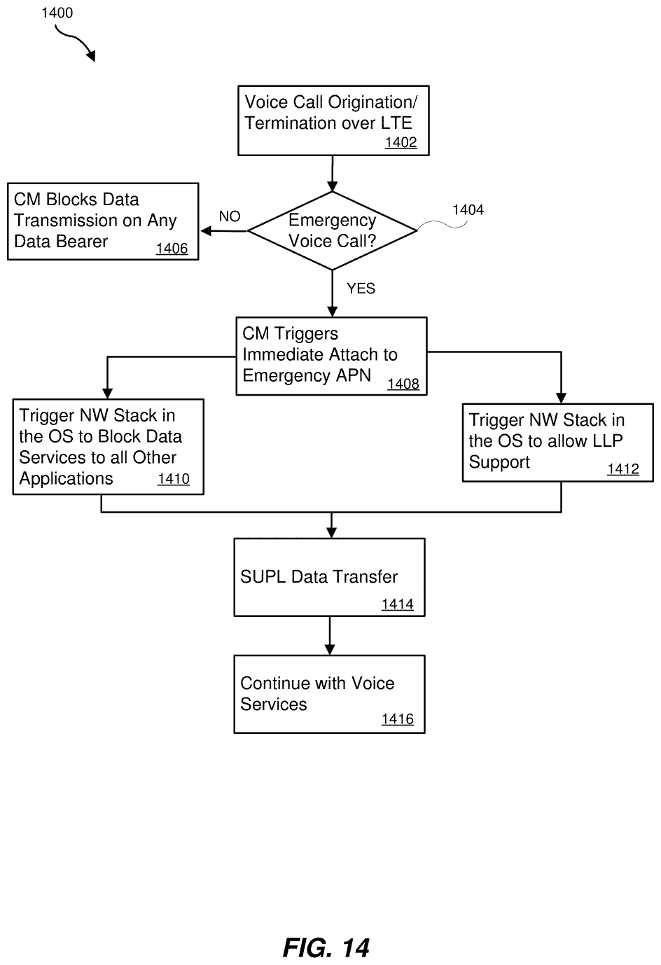

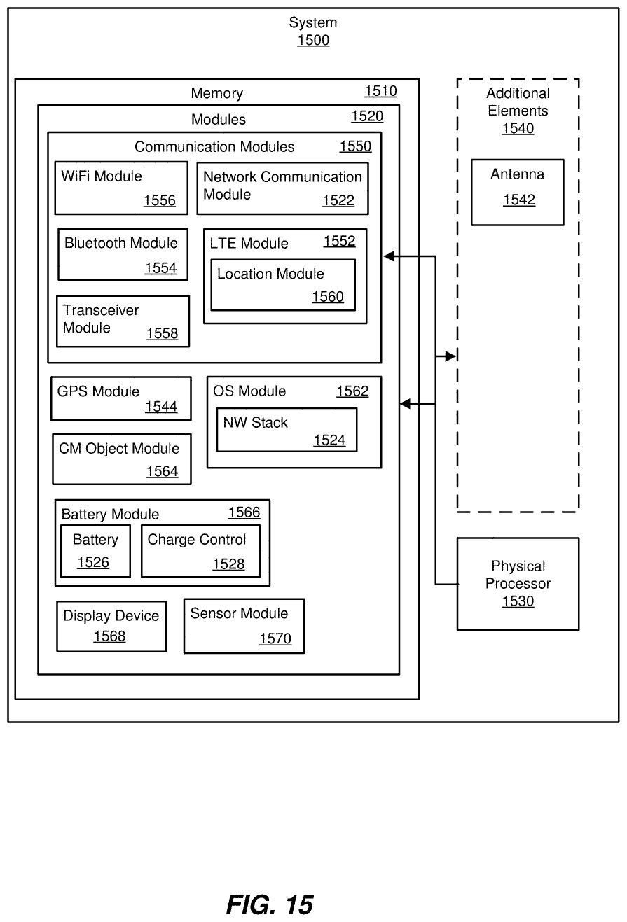

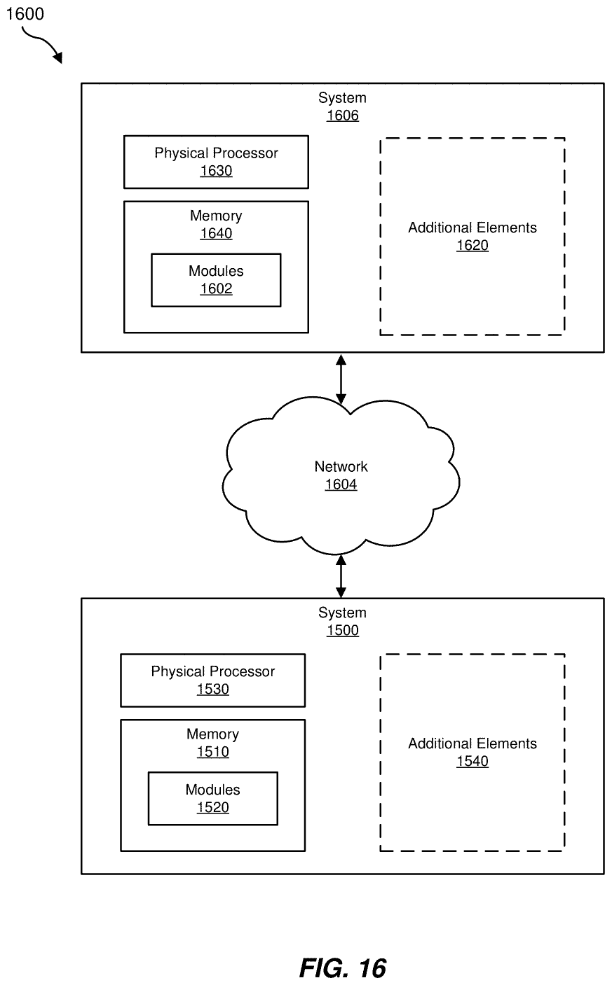

FIG. 14 is a flow diagram of an exemplary computer-implemented method 1400 for implementing an E911 emergency service on a mobile computing device. The steps shown in FIG. 14 may be performed by any suitable computer-executable code and/or computing system, including the system(s) illustrated in FIGS. 15 and 16. In one example, each of the steps shown in FIG. 14 may represent an algorithm whose structure includes and/or is represented by multiple sub-steps, examples of which will be provided in greater detail below.

As illustrated in FIG. 1400, at step 1402 one or more of the systems described herein may initiate (originate) or terminate a voice call over Long-Term Evolution (LTE). For example, an LTE module 1552 included in communication modules 1550 may initiate (originate) or terminate a voice call using the LTE communication standard.

In some embodiments, the term “voice call over LTE” may refer to the use of LTE communications that support a data bearer along with a Voice over LTE (VoLTE) (an audio or voice) bearer. The voice call over LTE may simultaneously transmit an LTE data bearer along with the VoLTE bearer. The voice call may originate from or terminate at a mobile computing device that performs wireless communications. Examples of wireless communications protocols and standards that a mobile computing device may use when placing a call to a wireless service provider may include, without limitation, LTE, VoLTE, cellular telecommunications, near field, WiFi, Bluetooth™ (BT), personal area network, 4G, 5G, 6G, etc.).

The systems described herein may perform step 1402 in a variety of ways. In one example, the system 1500 may initiate (originate) or terminate a voice call using an LTE module 1552 included in communication modules 1550.

As illustrated in FIG. 1400, at step 1404 one or more of the systems described herein may determine if the voice call is an emergency voice call. For example, a call manager (CM) object module 1564 may determine if the voice call is an emergency voice call.

In some embodiments, the term “emergency voice call” may refer to an enhanced 911 (E911) call, an E911 service, or an E911 service call. E911 may automatically report a telephone number and a location of a 911 call made from a phone. A wireless cellular network telecommunication carrier may provide E911 service capabilities for wireless 911 calls originating from a mobile computing device such as the system 1500. In some implementation, the wireless telephone carrier may provide a Public Safety Answering Point (PSAP) (e.g., a 911 dispatcher in a call center) with the telephone number of the originator of the wireless 911 call (e.g., a telephone number associated with the system 1500) and a Global Positioning System (GPS) location of the mobile computing device (e.g., latitude and longitude coordinates determined by a GPS module 1544) while the user of the mobile computing device is speaking with a 911 dispatcher. In some implementations that utilize VoLTE, secure user plane location (SUPL) based location data may be used to identify a location of the mobile computing device while placing the E911 call. For example, a location module 1560 included in the LTE module 1552 may determine and provide the SUPL data.

The systems described herein may perform step 1404 in a variety of ways. In one example, the system 1500 may use the CM object module 1564 to determine if the voice call is an emergency voice call. The system 1500 may establish a voice call over LTE by way of a network (e.g., network 1604) using a wireless cellular service provider. In some implementations, once the voice call is established over LTE, the CM object module 1564 may identify a session internet protocol (SIP) INVITE message. The SIP INVITE message may initiate a dialog between the originator of the call (e.g., the system 1500) and the receiver of the call (e.g., system 1606). For example, a user agent client (e.g., the system 1500) may send a message to a user agent server (e.g., the system 1606) by way of the network 1604. The system 1500 may send the SIP INVITE message with a common reserved “SOS” identifier. The CM object module 1564 may determine whether the SIP INVITE message used to initiate the call includes the “SOS” identifier. The CM object module 1564 determines that the voice call is an emergency call if the SIP INVITE message includes the “SOS” identifier. Alternatively, the CM object module 1564 determines that the voice call is not an emergency call if the SIP INVITE message does not include the “SOS” identifier.

As illustrated in FIG. 1400, at step 1406 one or more of the systems described herein may block data transmission on any data bearer. For example, the CM object module 1564, on determining that that the voice call is not an emergency call, may block data transmission between the call originator (e.g., the system 1500) and the call recipient (e.g., the system 1606) on any and all data bearers (e.g., cellular and/or WiFi and/or Bluetooth).

In some embodiments, the term “bearer” may refer to a tunnel used to connect user equipment (e.g., the system 1500) to Packet Data Networks (PDNs) such as the Internet by way of the network 1604. For example, bearers may be concatenated tunnels that connect the user equipment to the PDNs through a Packet Data Network Gateway (P-GW).

In some embodiments, the term “data bearer” may refer tunnels used to transmit digital data between user equipment (e.g., the system 1500) and a recipient device (e.g., the system 1606). As described herein, LTE may support a data bearer along with a VoLTE bearer.

The systems described herein may perform step 1406 in a variety of ways. In one example, the system 1500 may block data transmission on any data bearer of the system 1500. In some implementations, the system 1500 may block digital data transmissions from the system 1500 to a receiving device (e.g., the system 1606) by way of the network 1604 by blocking digital data cellular transmissions from the transceiver module 1558 and the network communications module 1522. In some implementations, the system 1500 may block digital data transmissions from the system 1500 to a receiving device (e.g., the system 1606) by way of the network 1604 by blocking digital data transmissions from the WiFi module 1556. In some implementations, the system 1500 may block digital data transmissions from the system 1500 to a receiving device (e.g., the system 1606) by way of the network 1604 by blocking digital data transmissions from the Bluetooth module 1554. Because simultaneously transmitting digital data by way of a data bearer along with a VoLTE bearer may degrade the voice quality of the voice call transmission, blocking (not allowing) digital data transmissions from the system 1500 (e.g., blocking data transmission on any data bearer) may improve (may not degrade) the voice quality of the voice call transmission.

As illustrated in FIG. 1400, at step 1408 one or more of the systems described herein may trigger an immediate attach to an Emergency Access Point Name (APN). For example, the CM object module 1564, on determining that that the voice call is an emergency call, may trigger an immediate attach to an Emergency APN.

In some embodiments, the term “Emergency Access Point Name (APN)” may refer to a globally standardized subsystem number (GSSN) within a network. The Emergency APN (Em-APN) may support IP Multimedia Subsystem or IP Multimedia Core Network Subsystem (IMS) Emergency calls. An IMS Emergency call may include a common reserved “SOS” network identifier.

The systems described herein may perform step 1408 in a variety of ways. In one example, the system 1500 may utilize VoLTE IMS call origination using the EM-APN to place the E911 call. Based on the CM object module 1564 determining that the voice call is an emergency call because the SIP INVITE message used to initiate the call includes the “SOS” identifier, the CM object module 1564 may prioritize an attach to a network by triggering an immediate attach to the Em-APN with the “SOS” network identifier for placing the E911 call.

As illustrated in FIG. 14, at step 1410 one or more of the systems described herein may trigger a network stack in an operating system to block data services to all other applications running on the mobile computing device that is initiating (placing) the E911 call. For example, based on the CM object module 5164 triggering an immediate attach to the Em-APN, the CM object module 1564 may manage the control of the transmission of digital data (e.g., control data bearers) during the E911 call by applications running on the mobile computing device while the E911 call is being placed.

The systems described herein may perform step 1410 in a variety of ways. In one example, once the CM object module 1564 triggers the attach to the Em-APN, the CM object module 1564 may control the transmission of digital data (e.g., control data bearers) during the E911 call by applications running on the mobile computing device while the E911 call is being placed. For example, the CM object module 1564 may not allow (block) data service (e.g., the transmission of any digital data) by applications running on the system 1500 while the E911 call is being placed (e.g., for the duration of the E911 call). In some implementations, the CM object module 1564 may control the transmission of digital data during the E911 call by applications running on the mobile computing device while the E911 call is being placed by triggering a network (NW) stack 1524 included in an operating system module 1562 to block data service to these applications. For example, the CM object module 1564 may trigger the NW stack 1524 to not allow (block) PUSH services, streaming services, and/or messenger services that may be running on the mobile computing device.

As illustrated in FIG. 14, at step 1412 one or more of the systems described herein may trigger a network stack in an operating system to allow (not block) LTE positioning protocol (LPP) process support. For example, based on the CM object module 1564 triggering an immediate attach to the Em-APN, the CM object module 1564 may manage the LLP process support for the E911 call.

In some embodiments, the term “LTE positioning protocol (LPP) process” may refer to an LTE positioning process that may establish point-to-point communications between a location server on a communications network (e.g., the network 1504) and a target device (e.g., the system 1500) in order to position the target device using position-related measurements obtained by one or more reference sources. For example, the location module 1560 included in the LTE module 1552 may initiate a communication session between the location server and the system 1500 to obtain location related data. The location related data may be referred to as secure user plane location (SUPL) based location data.

In some embodiments, the term “network stack (NW stack)” may refer to a protocol stack for a communication protocol used by a computing device. The stack may include operations or commands for use by the communication protocol when implemented by the computing device.

The systems described herein may perform step 1412 in a variety of ways. In one example, once the CM object module 1564 triggers the attach to the Em-APN, the CM object module 1564 may allow the NW stack 1524 to be triggered to receive SUPL data from the location module 1560 of the LTE module 1552. In some implementations, the location module 1560 may implement an LTE positioning protocol (LPP) process to obtain the SUPL data from a location server included in a communications network.

As illustrated in FIG. 1400, at step 1414 one or more of the systems described herein may transfer, transmit, or provide secure user plane location (SUPL) based location data. For example, the location module 1560, as part of VoLTE communications for the E911 call, may transmit the SUPL data.

In some embodiments, the term “secure user plane location (SUPL) based location data” may refer to data representative of a geographic location of a computing device that executes, for example, a LPP process. In some implementations, SUPL data may be obtained faster and may provide greater sensitivity as compared to GPS data. In some implementations, SUPL data may be used in combination with GPS data to better determine or identify a location of a computing device (e.g., assisted GPS).

The systems described herein may perform step 1402 in a variety of ways. In one example, the location module 1560 may implement an LPP process to obtain the SUPL data from a location server included in communications network (e.g., the network 1604). The LTE module 1552, as part of VoLTE communications for the E911 call, may provide the SUPL data as digital data along with the voice data to the Public Safety Answering Point (PSAP).

As illustrated in FIG. 1400, at step 1416 one or more of the systems described herein may continue with voice services. For example, the system 1500, and specifically one or more of the communication modules 1550 may continue to provide voice services.

The systems described herein may perform step 1416 in a variety of ways. In one example, the LTE module 1552 may continue to simultaneously transmit the LTE data bearer along with the VoLTE bearer. The LTE data bearer may provide the SUPL data and the VoLTE bearer may provide the voice data. Doing so may allow for transmission of digital data (e.g., the data bearer that provides location-based data) and voice data during an E911 call. The triggering of the NW stack 1524 in the OS module 1562 to block the use of transmission data services (e.g., block other applications running on the mobile computing device to also utilize the data bearer for the transmission) while the E911 call is being placed may allow the E911 service transmission to receive and provide location information for the system 1500 along with the voice data with little to no degradation of any of the data resulting in a valuable important user experience.

FIG. 15 is a block diagram of an example system 1500 that includes modules for use in implementing E911 call support for a mobile computing device. The system 1500 may be any of the mobile computing devices described herein that provide E911 call services such as wearable mobile computing devices, cellular phones, smartwatches, smartphones, etc.

Modules 1520 may include the communication modules 1550, operating system (OS) module 1562, Call Manager (CM) object module 1564, GPS module 1544, battery module 1566, display device 1568, and sensor module 1570. Although illustrated as separate elements, one or more of modules 1520 in FIG. 15 may represent portions of a single module or application.

In certain embodiments, one or more of modules 1520 in FIG. 15 may represent one or more software applications or programs that, when executed by a computing device, may cause the computing device to perform one or more tasks. As illustrated in FIG. 15, example system 1500 may also include one or more memory devices, such as memory 1510. Memory 1510 generally represents any type or form of volatile or non-volatile storage device or medium capable of storing data and/or computer-readable instructions. In one example, memory 1510 may store, load, and/or maintain one or more of modules DD20. Examples of memory 1510 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory. The memory 1510 may include a network (NW) data stack 1572.

As illustrated in FIG. 15, example system 1500 may also include one or more physical processors, such as physical processor 1530. Physical processor 1530 generally represents any type or form of hardware-implemented processing unit capable of interpreting and/or executing computer-readable instructions. In one example, physical processor 1530 may access and/or modify one or more of modules 1520 stored in memory 5110. Additionally, or alternatively, physical processor 1530 may execute one or more of modules 1520. Examples of physical processor DD30 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

As illustrated in FIG. 15, example system 1500 may also include one or more additional elements 1540. The additional elements 1540 generally represent any type or form of hardware and/or software. In one example, physical processor 1530 may access and/or modify one or more of the additional elements 1540.

In some implementations, the additional elements 1540 may be included (part of) the system 1500. In some implementations, the additional elements 1540 may be external to the system 1500 and accessible by the system 1500. The additional elements 1540 may include an antenna 1542.

The communication modules 1550 may include a Bluetooth module 1554, the LTE module 1552, a WiFi module 1556, a network communication module 1522, and a transceiver module 1558. The Bluetooth module 1554 may be hardware, firmware, and/or software configured to implement Bluetooth communications between the system 1500 and other Bluetooth enabled devices. The transceiver module 1558 may include hardware and/or software and may be configured to implement wireless communications between the system 1500 and other computing devices by wirelessly interfacing with or connecting to a cellular telecommunications network. The WiFi module 1556 may be hardware, firmware, and/or software configured to implement WiFi communications between the system 1500 and other WiFi enabled networks and/or devices. The network communication module 1522 may be hardware, firmware, and/or software configured to implement wired and/or wireless communications between the system 1500 and other computing devices connected to or interfaced with a network by way of the network. For example, the network communication module 1522 may implement wired and/or wireless communications between the system 1500 and other computing devices by way of a network.

The LTE module 1552 may include hardware and/or software and may be configured to implement LTE communications (e.g., LTE, VoLTE) between the system 1500 and a wireless communications service provider. The LTE module 1552 may include the location module 1560. For example, the location module 1560 include hardware and/or software and may be configured to initiate a communication session between a location server included in a communications network (e.g., the network 1604) and the system 1500 to obtain location related data. The location module 1560 may be configured to implement an LTE positioning protocol (LPP) process to obtain secure user plane location (SUPL) based location data from the location server.

The communication modules 1550 may interface with an antenna 1542 included in the additional elements 1540. In some implementations, the antenna 1542 may be a radio frequency (RF) antenna implemented using multiple antennae. The system 1500 (e.g., the transceiver module 1558) may use the antenna 1542 when placing an E911 service call from the system 1500 to a wireless service provider by way of a wireless communications cellular network.

The operating system (OS) module 1562 may include hardware and/or software and may be configured to execute an operating system on the system 1500. The OS module 1562 may include the network (NW) stack 1524. The NW stack 1524 may be a protocol stack for a communication protocol used by a computing device. For example, the NW stack 1524 may include protocol instructions or commands for voice and data services utilized by VoLTE communications. The CM object module 1564, as described herein, may block and/or allow instructions or commands on the NW stack.

The battery module 1566 may be hardware, firmware, and/or software configured to provide battery power to the system 1500. The battery module 1566 may include one or more batteries (e.g., battery 1526) and a charge control module 1528 for providing and controlling the charging of the battery 1526.

A display device 1568 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. In addition, or in the alternative, the display device may be a touchscreen. The display device 1568 may display information and data for use by a user of the system 1500 when interacting with the system 1500, and in particular, when placing an E911 call.

A sensor module 1570 may include hardware and/or software and may be configured to provide video, audio, haptic feedback, or some combination thereof, to a user of the system 1500.

FIG. 16 illustrates an exemplary network environment 1600 in which aspects of the present disclosure may be implemented. The network environment 1600 may include one or more computing devices (e.g., system 1500 and system 1606) and a network 1604. The system 1606, though shown as a single system may represent multiple same or different systems that the system 1500 may communicate with by way of the network 1604.

In one example, referring to FIG. 15, the system 1606 may be a computing device (e.g., a server system) that receives an E911 call from the system 1500. In this example, the system 1606 may represent a Public Safety Answering Point (PSAP) system. In another example, the system 1606 may be a system or server that may provide GPS location coordinates (e.g., latitude and longitude coordinates) of the system 1500. In another example, the system 1606 may represent a location server used by the system 1500 to obtain location related data for the system 1500. In this example, the location module 1560 of the LTE module 1552 may establish point-to-point communications between the location server (e.g., the system 1606) and a target device (e.g., the system 1500) using a communications network (e.g., the network 1604) in order to position the target device using position-related measurements obtained by one or more reference sources.

The system 1606 may include a physical processor 1630 that may be one or more general-purpose processors that execute software instructions. The system 1606 may include a data storage subsystem that includes a memory 1640, which may store software instructions, along with data (e.g., input and/or output data) processed by execution of those instructions. The memory 1640 may include modules 1602 that may be used to control the operation of the system 1606. The system 1606 may include additional 1620. In some implementations, all or part of the additional elements 1620 may be external to the system 1606 and the system 1500 and may be accessible by the system 1500 either directly (a direct connection) or by way of the network 1604.

The system 1500 may be communicatively coupled to the system 1606 through the network 1604. The network 1604 may be any communication network, such as a telecommunications network, a cellular network, the Internet, a Wide Area Network (WAN), or a Local Area Network (LAN), and may include various types of communication protocols and physical connections. The system 1500 may communicatively connect to and/or interface with various devices through the network 1604. In some embodiments, the network 1604 may support communication protocols such as LTE, VoLTE, transmission control protocol/Internet protocol (TCP/IP), Internet packet exchange (IPX), systems network architecture (SNA), and/or any other suitable telecommunications and/or network protocols. In some embodiments, data may be transmitted by the network 1604 using a mobile network (such as a mobile telephone network, cellular network, satellite network, or other mobile network), a public switched telephone network (PSTN), wired communication protocols (e.g., Universal Serial Bus (USB), Controller Area Network (CAN)), and/or wireless communication protocols (e.g., wireless LAN (WLAN) technologies implementing the IEEE 802.11 family of standards, Bluetooth, Bluetooth Low Energy, Near Field Communication (NFC), Z-Wave, and ZigBee).

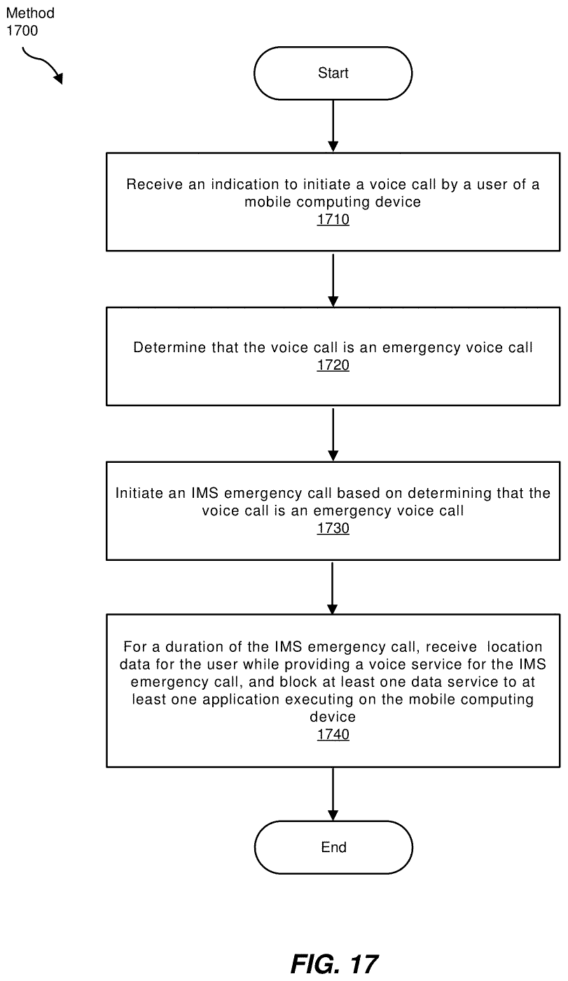

FIG. 17 is a flow diagram of an exemplary computer-implemented method 1700 for providing emergency voice call services and support on mobile computing devices. The steps shown in FIG. 17 may be performed by any suitable computer-executable code and/or computing system, including the system(s) illustrated in FIGS. 15 and 16. In one example, each of the steps shown in FIG. 17 may represent an algorithm whose structure includes and/or is represented by multiple sub-steps, examples of which will be provided in greater detail below.

As illustrated in FIG. 17, at step 1710 one or more of the systems described herein may receive, by a mobile computing device, an indication to initiate a voice call by a user of the mobile computing device. For example, the system 1500 may receive an indication for a user of the system 1500 to initiate a voice call.

In some embodiments, the term “voice call” may refer to placing a phone call from a mobile computing device that includes voice data and, in some cases, digital data indicative of a location of the mobile computing device. The voice call may be placed from the mobile computing device using a communication protocol. Examples of communication protocols may include, without limitation, Long-Term Evolution (LTE) wireless broadband communications, Voice over Long-Term Evolution (VoLTE) wireless broadband communications, cellular, near field, wireless fidelity (WiFi), Bluetooth™ (BT), personal area network, 4G, 5G, 6G, etc.).

The systems described herein may perform step 1710 in a variety of ways. In one example, referring to FIG. 13, the user 1306 may interact or interface with a touchscreen 1304 of the mobile computing device 1302 to initiate the call. In another example, the user 1306 may interface or interact with the mobile computing device 1302 using one or more voice commands to initiate the call. In another example, referring to FIG. 8, a user may interact with the smartwatch 800 to initiate the call.

As illustrated in FIG. 17, at step 1720 one or more of the systems described herein may determine, by the mobile computing device, that the voice call is an emergency voice call. For example, the CM object module 1564 may determine that the voice call is an emergency voice call.

In some embodiments, the term “emergency call” may refer to an Enhanced 911 call or E911 call. The use of an Enhanced 911 (E911) service may allow for reporting of a telephone number and a location of a 911 call made from a mobile computing device.

The systems described herein may perform step 1720 in a variety of ways. In one example, the CM object module 1564 may identify a session internet protocol (SIP) INVITE message that includes an “SOS” identifier indicating that the voice call is an emergency call.

As illustrated in FIG. 17, at step 1730 one or more of the systems described herein may initiate, on the mobile computing device, an Internet Protocol Multimedia Subsystem (IMS) emergency call based on determining that the voice call is an emergency voice call. For example, the LTE module 1552 may initiate the IMS emergency call.

In some embodiments, the term “Internet Protocol Multimedia Subsystem (IMS) emergency call” may refer to IP Multimedia Subsystem or IP Multimedia Core Network Subsystem (IMS) Emergency calls supported by the Emergency APN (Em-APN) globally standardized subsystem number (GSSN) within a network. An IMS Emergency call may include a common reserved “SOS” network identifier. A non-limiting example of an IMS emergency call includes an Enhanced 911 (E911) call.

The systems described herein may perform step 1730 in a variety of ways. In one example, the LTE module 1552 may initiate the IMS emergency call as a VoLTE E911 call.

As illustrated in FIG. 17, at step 1740 one or more of the systems described herein may, for a duration of the IMS emergency call, receive, by the mobile computing device, location data for the user while providing a voice service for the IMS emergency call, and block, by the mobile computing device, at least one data service to at least one application executing on the mobile computing device.

The systems described herein may perform step 1740 in a variety of ways. In one example, for the duration of the IMS emergency call, a CM object (e.g., the CM object module 1564) may not allow (block) data service (e.g., the transmission of any digital data) by applications running on the mobile computing device (e.g., the system 1500). In some implementations, for the duration of the IMS emergency call, a CM object (e.g., the CM object module 1564) may control the transmission of digital data during the IMS emergency call by applications running on the mobile computing device during the call by triggering a network stack (e.g., the NW stack 1524) to block data service to these applications. For example, the CM object module 1564 may trigger the NW stack 1524 to not allow (block) PUSH services, streaming services, and/or messenger services that may be running on the mobile computing device. Additionally, or alternatively, for the duration of the IMS emergency call, a CM object (e.g., the CM object module 1564) may allow (not block) a network stack (e.g., the NW stack 1524) to be triggered to receive SUPL data (e.g., location data from the location module 1560 of the LTE module 1552).

### EXAMPLE EMBODIMENTS

Example 32: An example computer-implemented method may include receiving, by a mobile computing device, an indication to initiate a voice call by a user of the mobile computing device, determining, by the mobile computing device, that the voice call is an emergency voice call, initiating, on the mobile computing device, an Internet Protocol Multimedia Subsystem (IMS) emergency call based on determining that the voice call is an emergency voice call, and for a duration of the IMS emergency call, receiving, by the mobile computing device, location data for the user while providing a voice service for the IMS emergency call, and blocking, by the mobile computing device, at least one data service to at least one application executing on the mobile computing device.

Example 33: The computer-implemented method of Example 32, where the mobile computing device may be a wearable device of a user.

Example 34: The computer-implemented method of Examples 32 or 33, where the mobile computing device may receive the indication to initiate the voice call while the user is wearing the mobile computing device.

Example 35: The computer-implemented method of any of Examples 32-34, where determining that the voice call is an emergency voice call may include identifying, by a call manager of the mobile computing device, a session internet protocol INVITE message with an SOS for establishing the voice call as the emergency voice call.

Example 36: The computer-implemented method of any of Examples 32-35, where the at least one data service may be one of a PUSH service, a streaming service, or a messenger service.

Example 37: The computer-implemented method of any of Examples 32-36, where the IMS emergency call utilizes a Voice over Long-Term Evolution (VoLTE) communication standard for the voice service for the IMS emergency call.

Example 38: The computer-implemented method of any of Examples 32-37, where receiving location data for the user while providing the voice service for the IMS emergency call may include receiving secure user plane location (SUPL) information from a Long-Term Evolution positioning protocol (LPP) process of the VoLTE communication standard.

### Example Systems, Methods, and Devices for Automatic Content Display

Wearable devices may be configured to be worn on a user's body part, such as a user's wrist or arm. Such wearable devices may be configured to perform various functions. A wristband system (e.g., a smartwatch) may be an electronic device worn on a user's wrist that performs functions such as displaying content to the user, executing social media applications, executing artificial-reality applications, messaging, web browsing, sensing ambient conditions, interfacing with head-mounted displays, monitoring the health status associated with the user, etc. However, since wearable devices are typically worn on a body part of a user, a wristband system may present challenges to automatically display content to the user. The challenges may include automatically displaying content to the user on demand when the user places a display screen of the wristband system in the field of view of the user, preventing viewing of the content by those other than the user, and conserving battery power when display content is not demanded by the user.

The present disclosure details systems, devices, and methods related to a wristband system that automatically displays content to a user upon demand. For example, a user may execute a gesture of bringing a display screen of the wristband system up to the user's face in order to view content. The wristband system may detect the gesture, determine that the user is looking at the display screen, and automatically display content to the user. The present disclosure further details systems, devices, and methods related to training at least one model in a wristband system that detects a gesture of a user bringing the wristband system into the field of view of the user and/or performs facial recognition to determine that a user is looking at the display screen.

Advantages of the present disclosure may include reducing an overall power consumption and extending battery charge time of the wristband system by enabling the wristband system to control the display power consumption based on whether the user is looking at the display. Another potential advantage of the present disclosure may include increasing the security of content displayed on the wristband system by only displaying content when the user is looking at the display and not displaying content when the display is not in the field of view of the user. Another potential advantage of the present disclosure may include increasing user convenience when viewing content by automatically displaying content to the user without user input (e.g., button push, screen wipe, tapping, voice input, etc.)

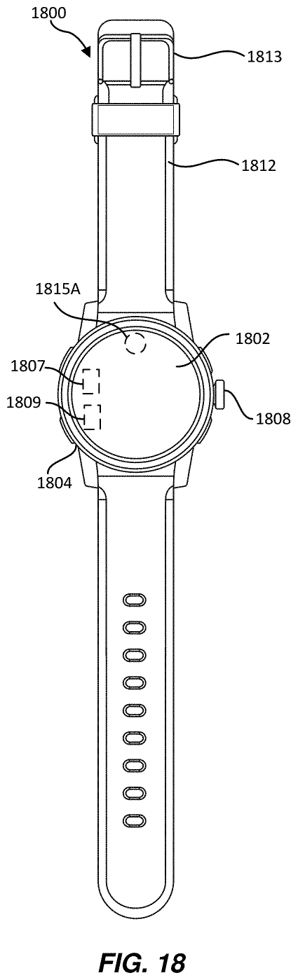

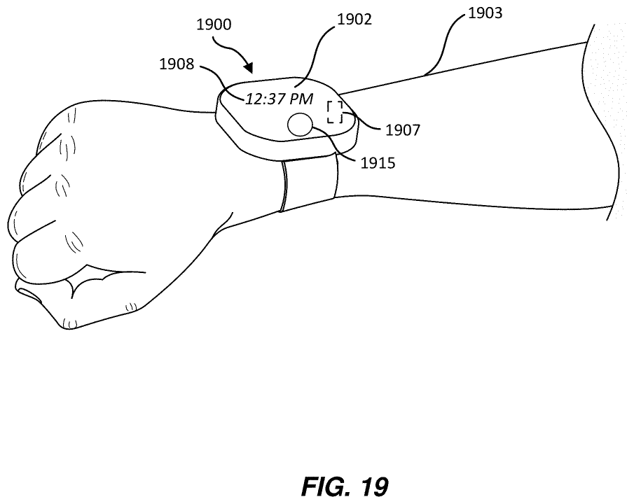

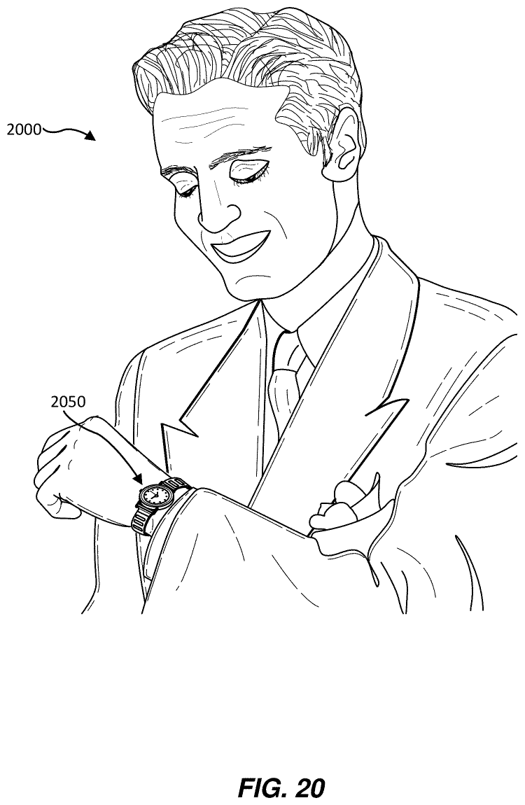

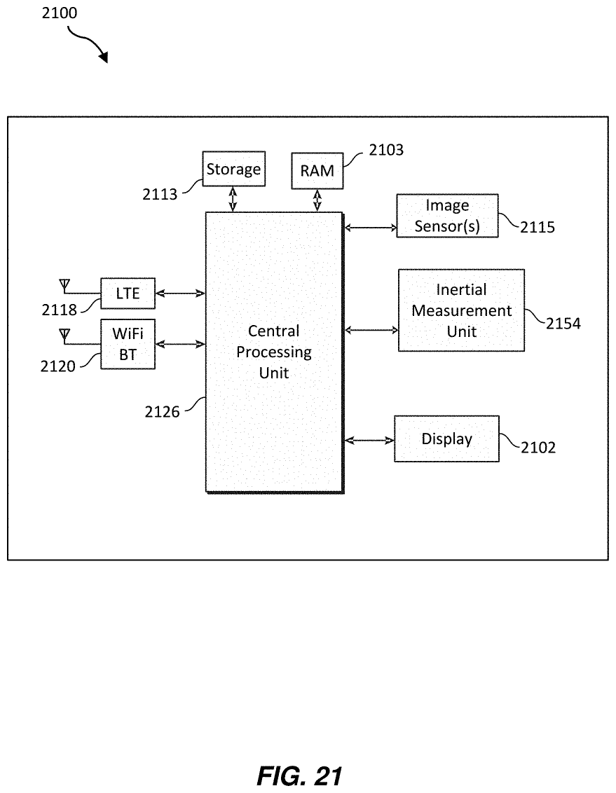

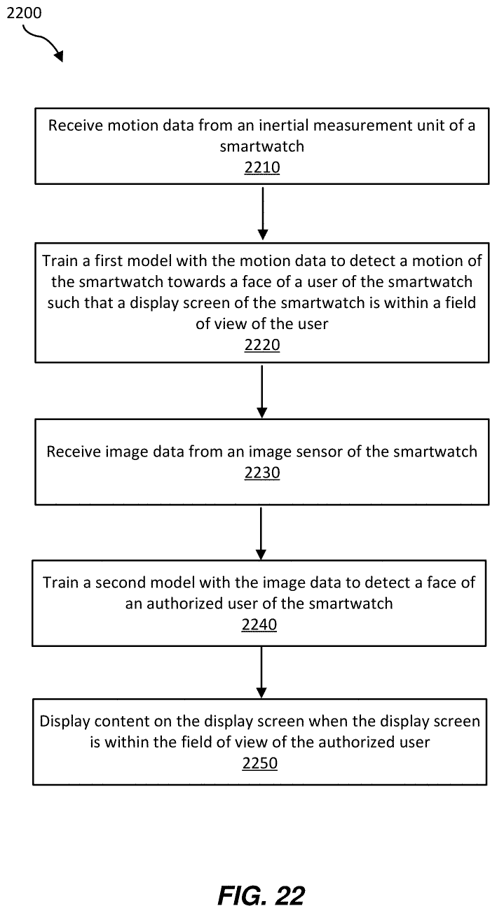

The following will provide, with reference to FIGS. 18-22, detailed descriptions of automatically displaying content on a wristband system including related devices and methods. First, a description of a wristband system is presented with reference to FIG. 18. A description of a wristband image sensor capable of recognizing an image of a user is presented with reference to FIG. 19. A description of a user viewing content automatically displayed on a wristband system is presented with reference to FIG. 20. An example block diagram of a wristband system capable of automatically displaying content to a user is presented with reference to FIG. 21. A method of training at least one model (e.g., a neural network) to automatically display content to a user is presented with reference to the flowchart of FIG. 22.

FIG. 18 illustrates an example wristband system 1800 that includes a watch body 1804 coupled to a watch band 1812. Watch body 1804 and watch band 1812 may have any size and/or shape that is configured to allow a user to wear wristband system 1800 on a body part (e.g., a wrist). Wristband system 1800 may include a retaining mechanism 1813 (e.g., a buckle) for securing watch band 1812 to the user's wrist. Wristband system 1800 may also include a coupling mechanism for detachably coupling watch body 1804 to watch band 1812. Wristband system 1800 may perform various functions associated with the user. In some examples, watch band 1812 and/or watch body 1804 may each include the independent resources required to independently execute functions.

Functions that may be independently executed by watch body 1804, by watch band 1812, or by wristband system 1800 may include, without limitation, automatic display of visual content to the user on display screen 1802, image capture (e.g., with a front-facing image sensor 1815A and/or a rear-facing image sensor), facial recognition, gesture (e.g., motion) detection, sensing user input (e.g., sensing a touch on button 1808, sensing biometric data with sensor 1814, etc.), messaging (e.g., text, speech, video, etc.), wireless communications (e.g., cellular, near field, WiFi, personal area network, etc.), location determination, financial transactions, providing haptic feedback, etc.

In some examples, display screen 1802 may display visual content to the user when display screen 1802 is determined to be within the field of view of front facing image sensor 1815A. Front facing image sensor 1815A may capture images within a wide angle field of view. The angle of the wide angle field of view may be within a range of about 90 degrees to about 135 degrees. A processor 1809 of wristband system 1800 may use facial recognition techniques on the images acquired by front facing image sensor 1815A to determine if a user's face is with the field of view of front facing image sensor 1815A. In some examples, processor 1809 may receive data from an inertial measurement unit (IMU) 1807 to determine the motion (e.g., three-dimensional motion) of wristband system 1800. Content may be displayed on display screen 1802 when the motion data indicates that display screen 1802 is determined to be within the field of view of the user and the face of the user is determined to be within the field of view of front facing image sensor 1815A.

In some examples, wristband system 1800 may determine if the user in the field of view of front facing image sensor 1815A is an authorized user and only display content to the authorized user. In some examples, processor 1809 may be further configured to determine a size of the user's face within the field of view of front facing image sensor 1815A. The size of the face may indicate if the face belongs to the user (e.g., the person wearing wristband system 1800) or the face of a person nearby to the user. Wristband system 1800 may display content on display screen 1802 when the size of the detected face is greater than a threshold in order to display the content only to the user. In some examples, a user may experience a small or an imperceptible latency from the time the user moves watch body 1804 in front of the user's face until the content is automatically displayed. This latency may be about 100 ms and may be caused by the time required for facial recognition processing of the captured images.

In some examples, watch body 1804 may determine an orientation of display screen 1802 relative to an eye gaze direction of a user and may orient content viewed on display screen 1802 to the eye gaze direction of the user. The displayed visual content may be oriented to the eye gaze of the user such that the content is easily viewed by the user, in some cases without user intervention.

Embodiments of the present disclosure may orient (e.g., rotate, flip, stretch, etc.) the displayed content such that the displayed content remains in substantially the same orientation relative to the eye gaze of the user (e.g., the direction in which the user is looking). The displayed visual content may also be modified based on the eye gaze of the user without user intervention. For example, in order to reduce the power consumption of wristband system 1800, display screen 1802 may dim the brightness of the displayed content, pause the displaying of video content, or power down display screen 1802 when it is determined that the user is not looking at display screen 1802 (e.g., when a trained model executed by processor 1809 does not detect the motion of the user raising display screen 1802 to the user's face and front facing image sensor 1815A does not detect the user's face). In some examples, one or more sensors of wristband system 1800 may determine an orientation of display screen 1802 relative to an eye gaze direction of the user.

Embodiments of the present disclosure may measure the position, orientation, and/or motion of the face of the user in a variety of ways, including through the use of facial recognition, optical-based eye-tracking techniques, ultrasound-based eye-tracking techniques, etc. For example, front facing image sensor 1815A may capture images of the user's eyes and determine the eye gaze direction based on processing of the captured images.

In some examples, watch body 1804 may be configured to automatically display content to the user of watch body 1804 and not display the content to others nearby. For example, processor 1809 may be configured to analyze the images captured by front-facing image sensor 1815A and determine a relative size of the face of the user as perceived by the image sensor and display content on the display screen when the size of the face of the user is greater than a threshold. When the size of the face of the user is less than a threshold, front-facing image sensor 1815A may have captured images of a person nearby and watch body 1804 may be configured to not display content on display screen 1802.

In some examples, IMU 1807 may be configured to continually detect the motion of watch body 1804. By continually detecting the motion of watch body 1804, processor 1809 may continually analyze the motion data (e.g., using a trained neural network model) to determine when the user performs a motion to raise watch body 1804 towards the user's face. Front-facing image sensor 1815A may be configured to capture at least one image after processor 1809 has determined that the motion of watch body 1804 includes the motion towards the face of the user.

FIG. 19 is a perspective view of a user wearing a smartwatch 1900 (e.g., a wristband system), according to at least one embodiment of the present disclosure. A user may wear smartwatch 1900 on any body part. For example, a user may wear smartwatch 1900 on a forearm 1903. In some examples, smartwatch 1900 may include a front facing image sensor 1915. Front-facing image sensor 1915 may be located in a front face of smartwatch 1900. Front-facing image sensor 1915 may capture an image (e.g., a still image or a video) of the user.

In some embodiments, front facing image sensor 1915 may be a wide-angle image sensor that may be configured to capture a field of view surrounding smartwatch 1900. Smartwatch 1900 may include a display screen 1902 and an IMU 1907 configured to record motion data of smartwatch 1900. Front-facing image sensor 1915 may be positioned and configured to capture at least one image of a user of smartwatch 1900. A processor of smartwatch 1900 may use recorded data from IMU 1907 to determine that the motion of smartwatch 1900 includes a motion towards a face of a user of smartwatch 1900 as shown in FIG. 3. For example, a user wearing smartwatch 1900 may execute a motion (e.g., a gesture) of turning and sweeping the user's forearm 1903 up towards the face of the user in order to view content 1908 (e.g., the time of day) on display screen 1902. The processor may determine that the face of the user is within a field of view of front-facing image sensor 1915 based on the captured images. In some examples, smartwatch 1900 may display content 1908 on display screen 1902 when display screen 1902 is determined to be within the field of view of the user and the face of the user is determined to be within the field of view of front-facing image sensor 1915. Smartwatch 1900 may not display content 1908 on display screen 1902 and/or turn off display screen 1902 in order to conserve battery power when the processor determines that the user is no longer within the field of view of front-facing image sensor 1915.

FIG. 20 illustrates a user 2000 viewing content on a smartwatch 2050, according to at least one embodiment of the present disclosure. User 2000 may wear smartwatch 2050 on a wrist and desire smartwatch 2050 to automatically display content (e.g., the time of day, messages, etc.) when user 2000 looks at the screen of smartwatch 2050. The user may further desire smartwatch 2050 to not display content and/or turn off the display screen in order to conserve battery power and protect the displayed content from being viewed by others in the area when the user is no longer looking at smartwatch 2050. As shown in FIG. 20, user 2000 may execute a motion to raise smartwatch 2050 towards the face of user 2000. Smartwatch 2050 may be trained to detect the motion and turn on an image sensor to collect images. When smartwatch 2050 detects the face of user 2000 (e.g., by performing facial recognition), content may be automatically displayed on smartwatch 2050.

FIG. 21 is a block diagram of an example smartwatch 2100, according to at least one embodiment of the present disclosure. Referring to FIG. 21, smartwatch 2100 may include processor 2126, image sensor 2115, IMU 2154, display screen 2102, storage 2113, random access memory (RAM) 2103, and communication devices LTE 2118 and WiFi/Bluetooth™ 2120. In some examples, IMU 2154 may be configured to detect a three-dimensional motion of smartwatch 2100. Image sensor 2115 may be disposed on a front surface of smartwatch 2100 and configured to capture at least one image of a user of smartwatch 2100. Processor 2126 may be configured to determine that the motion of smartwatch 2100 includes a motion towards a face of a user.

For example, a user wearing smartwatch 2100 may execute a motion (e.g., a gesture) of sweeping the user's arm up towards the face of the user in order to view content on display screen 2102. Processor 2126 may determine that the face of the user is within a field of view of image sensor 2115 based on the captured images. In some examples, smartwatch 2100 may automatically display content (e.g., time of day, messages, reminders, photos, etc.) on display screen 2102 when display screen 2102 is determined to be within the field of view of the user (e.g., based on the motion data) and the face of the user is determined to be within the field of view of image sensor 2115. In some examples, smartwatch 2100 may display content only when the user is an authorized user of the smartwatch. In some examples, a user may experience a latency (e.g., a small or an imperceptible latency) from the time the user moves smartwatch 2100 in front of the user's face until the content is automatically displayed. The latency may be about 100 ms and may be caused by the time required for facial recognition processing of the captured images.

In some examples, smartwatch 2100 may be configured to automatically display content to the user of smartwatch 2100 and not display the content to others nearby. For example, processor 2126 may be configured to analyze the images captured by image sensor 2115 and determine a size of the face of the user as perceived by the image sensor and display content on display screen 2102 when the relative size of the face of the user is greater than a threshold. When the size of the detected face is less than the threshold, image sensor 2115 may have captured images of a person nearby and smartwatch 2100 may be configured to not display content on display screen 2102 in order to hide the content from the nearby person.

In some examples, IMU 2154 may be configured to continually record motion data of smartwatch 2100. By continually recording motion data of smartwatch 2100, processor 2126 may continually analyze the motion data (e.g., using a trained neural network model) to determine when the user executes a motion (e.g., performs a gesture) to raise smartwatch 2100 towards the user's face. Image sensor 2115 may be configured to capture images after processor 2126 has determined that the motion of smartwatch 2100 includes the motion towards the face of the user. Image sensor 2115 may be configured not to capture images from image sensor 2115 until the gesture is detected in order to conserve battery power and retain privacy of the surrounding environment.

FIG. 22 is a flow diagram illustrating an example method 2200 of training at least one model to automatically display content to a user. At operation 2210, method 2200 may include receiving motion data from an IMU of a smartwatch. Operation 2210 may be performed in a variety of ways, as will be understood by one skilled in the art considering the present disclosure. For example, receiving motion data from an IMU of a smartwatch may be performed as described above with reference to FIG. 21.

At operation 2220, method 2200 may include training a first model with the motion data to detect a motion of the smartwatch towards a face of a user such that a display screen of the smartwatch is within a field of view of the user. Operation 2220 may be performed in a variety of ways. For example, a first model (e.g., a neural network, a recurrent neural network, etc.) may be trained in a supervised fashion by recording motion data from an IMU while a user is performing a motion of raising the smartwatch towards the user's face. The weights and biases of the first model may be back-propagated based on the recorded motion data. In another example, a time stamp of when the face of the user is detected by the image sensor may be logged. The motion data that is recorded during a time period preceding the time stamp may be used to train the first model.

At operation 2230, method 2200 may include receiving image data from an image sensor of the smartwatch. Operation 2230 may be performed in a variety of ways. For example, image data may be received from an image sensor of the smartwatch as described above with reference to FIGS. 18-22.

At operation 2240, method 2200 may include training a second model with the image data to detect a face of a user of the smartwatch. Operation 2240 may be performed in a variety of ways. For example, training a second model with the image data to detect a face of the user may include localization of facial features within the captured image. Training the second model may include distinguishing between the user and a nearby person by determining a size of the detected face as perceived by the image sensor and determining when the size of the face of the user is greater than a threshold.

At operation 2250, method 2200 may include displaying content on the display screen based on the trained first model and the trained second model when the display screen is within the field of view of the user and the face of the user is detected. Operation 2250 may be performed in a variety of ways. For example, displaying content on the display screen based on the trained first model and the trained second model when the display screen is within the field of view of the user and the face of the user is detected may be performed as described above with reference to FIGS. 18-22.

As described in detail above, the present disclosure details systems, devices, and methods related to a wristband system (e.g., a smartwatch) that automatically displays content to a user upon demand. For example, a user may execute a gesture of bring a display of the wristband system up to the user's face in order to view content. The wristband system may detect the gesture, determine that the user is looking at the display screen, and automatically display content to the user. The present disclosure further details systems, devices, and methods related to training at least one model in a wristband system that detects a gesture of a user bringing the wristband system into the field of view of the user and/or performs facial recognition to determine that a user is looking at the display.

### EXAMPLE EMBODIMENTS

Example 39: A smartwatch comprising a display screen an inertial measurement unit configured to detect a motion of the smartwatch, an image sensor configured to capture at least one image, and a processor configured to determine that the motion of the smartwatch includes a motion towards a face of a user of the smartwatch, determine that the face of the user is within a field of view of the image sensor based on the at least one captured image, and display content on the display screen when the display screen is determined to be within the field of view of the user and the face of the user is determined to be within the field of view of the image sensor.

Example 40: The system of Example 39, wherein the user is an authorized user of the smartwatch.

Example 41: The system of Example 39 or Example 40, wherein the processor is further configured to determine a size of the face of the user as perceived by the image sensor and display content on the display screen when the size of the face of the user is greater than a threshold.

Example 42: The system of any of Example 39 through Example 41, wherein the inertial measurement unit is further configured to continually detect the motion of the smartwatch and the image sensor is further configured to capture the at least one image after the processor has determined that the motion of the smartwatch includes the motion towards the face of the user of the smartwatch.

Example 43: A method comprising receiving motion data from an inertial measurement unit of a smartwatch, training a first model with the motion data to detect a motion of the smartwatch towards a face of a user of the smartwatch such that a display screen of the smartwatch is within a field of view of the user, receiving image data from an image sensor of the smartwatch, training a second model with the image data to detect a face of a user of the smartwatch, and based on the trained first model and the trained second model, displaying content on the display screen when the display screen is within the field of view of the user and the face of the user is detected.

Example 44: The method of Example 43, further comprising logging a time stamp of when the face of the user is detected and training the first model to detect the motion of the smartwatch based on motion data from the inertial measurement unit in a time period preceding the time stamp.

Example 45: The method of Example 43 or Example 44, further comprising training the second model to detect a face of an authorized user of the smartwatch.

Example 46: The method of any of Example 43 through Example 45, further comprising training the second model to determine a size of the face of the user as perceived by the image sensor and determine when the size of the face of the user is greater than a threshold.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A method comprising:
a processor;
a memory device comprising instructions that, when executed by the processor, perform at least one of:
a process for rotating images comprising:
capturing, using an optical sensor, image data;
determining a reference orientation associated with the captured image data;
rotating the captured image data based on the reference orientation; and
storing the rotated image data;
a process for batching messages comprising:
configuring a wireless communications unit of a first electronic device to a low power mode;
receiving, by a second electronic device, at least one message;
queuing, in a buffer memory of the second electronic device, the at least one message;
determining a threshold associated with the queued at least one message;
configuring the wireless communications unit of the first electronic device to a normal power mode; and
sending the at least one message from the second electronic device to the first electronic device when the threshold is exceeded;
a process for emergency calls comprising:
receiving, by a mobile computing device, an indication to initiate a voice call by a user of the mobile computing device;
determining, by the mobile computing device, that the voice call is an emergency voice call;
initiating, on the mobile computing device, an Internet Protocol Multimedia Subsystem (IMS) emergency call based on determining that the voice call is an emergency voice call; and
for a duration of the IMS emergency call:
receiving, by the mobile computing device, location data for the user while providing a voice service for the IMS emergency call; and
blocking, by the mobile computing device, at least one data service to at least one application executing on the mobile computing device; or
a process for updating smartwatch displays comprising:
receiving motion data from an inertial measurement unit of a smartwatch;
training a first model with the motion data to detect a motion of the smartwatch towards a face of a user of the smartwatch such that a display screen of the smartwatch is within a field of view of the user;
receiving image data from an image sensor of the smartwatch;
training a second model with the image data to detect a face of a user of the smartwatch; and
based on the trained first model and the trained second model, displaying content on the display screen when the display screen is within the field of view of the user and the face of the user is detected.

2. A system comprising at least one of:
an optical sensor device that comprises:
an optical sensor;
at least one physical processor; and
physical memory comprising computer-executable instructions that, when executed by the physical processor, cause the physical processor to:
capture, using the optical sensor, image data;
determine a reference orientation associated with the captured image data;
rotate the captured image data based on the reference orientation; and
store the rotated image data; or
a smartwatch that comprises:
a display screen;
an inertial measurement unit configured to detect a motion of the smartwatch;
an image sensor configured to capture at least one image; and
a processor configured to:
determine that the motion of the smartwatch comprises a motion towards a face of a user of the smartwatch;
determine that the face of the user is within a field of view of the image sensor based on the at least one captured image; and
display content on the display screen when the display screen is determined to be within the field of view of the user and the face of the user is determined to be within the field of view of the image sensor.

3. A system comprising:
a first device with a first clock;
a host system with a second clock, wherein the host system:
sends a first transmission to the first device at a first time measured by the first clock and identified by a first timestamp;
receives a second transmission from the first device at a fourth time measured by the first clock and identified by a fourth timestamp, wherein the second transmission comprises:
a second timestamp, measured by the second clock, indicating a second time at which the first transmission was received by the first device from the synchronization system; and
a third timestamp, measured by the second clock, indicating a third time at which the second transmission as sent by the first device to the host system; and
determines, based at least in part on the first, second, third, and fourth timestamps, an estimated offset of the second clock relative to the first clock and an estimated period of the second clock relative to the first clock.
